(19) United States
(12) Patent Application Publication
(10) Pub. No.: US 2008/0011643 A1
(43) Pub. Date: Jan. 17, 2008

(54) Use Of Field Gas For Pre-Refining Conventional Crude Oil Into A Pre-Refined Asphaltenes-Free Oil Refinery Feedstock Pa And A Liquid Residual Oil Refinery FeedStock Pb

(76) Inventors: Eric Lenglet, Rueil Malmaison (FR); Alexandre Rojey, Rueil Malmaison (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/591,339

(22) PCT Filed: Feb. 15, 2005
(86) PCT No.: PCT/IB05/00674

§ 371 Date: Sep. 19, 2007

(30) Foreign Application Priority Data
Mar. 1, 2004 (FR) 0402088

(51) Int. Cl. C10G 67/00; C01B 3/34; C10G 67/04; E21B 43/16; C10G 49/00

(52) U.S. Cl. 208/58

(57) ABSTRACT

Use, in a gas production region, of a purified field gas in which:

a) said gas is converted into hydrogen;

b) a conventional sulphur-containing transportable fluid crude P1 is supplied;

c) P1 is treated without discharging carbon, comprising

a desulphurizing treatment step by hydrotreatment, hydroconversion or hydrocracking of a fraction boiling above 343° C., consuming hydrogen;

a step for reducing the quantity of vacuum residue by segregation and/or conversion of a portion of said vacuum residue;

so as to produce a pre-refined asphaltenes-free oil refinery feedstock P_{A}, and a residual easily transportable liquid oil refinery feedstock;

d) evacuating said prerefined oil P_{A} to an oil port.

### FIELD OF THE INVENTION

The present invention relates to oil refining and the use of heavy sulphur-containing refinery residues. Oil is traditionally treated in the oil refinery by an ensemble of fractionation and chemical conversion operations to produce an ensemble of final commercial products satisfying well defined standards or technical specifications, for example distillation intervals, sulphur contents, or characteristic technical indices such as the octane index or diesel index, etc.

The principal final commercial products are petrochemical naphtha, gasoline, kerosene, gas oil (also known as diesel fuel), domestic fuel, and different categories of fuels with differing sulphur contents, road bitumen, liquid petroleum gas, and occasionally other products: lubricating oils, solvents, paraffin, etc. . . . Thus, an oil refinery produces a relatively large number of final commercial products from a certain number of crude oils selected as a function of their composition and cost.

Market development on the one hand, in particular the increasing competition from natural gas, and specifications regarding discharges from combustion facilities (oxides of sulphur, oxides of nitrogen, solid particles, in particular specifications in Europe) on the other hand have severely affected outlets for heavy sulphur-containing fuels, for example heavy fuel containing more than 3.5% or 4% of sulphur. Thus, refiners are faced with a major technical problem, that of using sulphur-containing residues from the refinery and satisfying regulatory requirements. That technical problem is not new, and it has been known for a number of years that refining, in particular in Europe, must rise to the challenge of a reduction in the markets for heavy fuel, in particular heavy sulphur-containing heavy fuel.

By way of indication, residues from refining Middle Eastern oil, which constitutes about two thirds of worldwide reserves of conventional oil, usually contain more than 3% and even 4% by weight of sulphur. However, new standards for combustion facilities in Europe are limited to using fuel with only 1% by weight of sulphur if the fumes are not desulphurized.

A great deal of work has been carried out to overcome this problem of using refinery sulphur-containing residues:
a first route is the development of high performance techniques for treating fumes from the combustion of sulphur-containing fuel, eliminating or reducing oxides of sulphur, oxides of nitrogen, and solid particles contained in the fumes. Certain techniques can substantially limit discharge and satisfy the regulations. Thus, certain markets for heavy sulphur-containing fuel can be retained, in particular the use of that type of fuel for internal consumption of fuel at the refinery. Unfortunately, such effluent treatment techniques considerably complicate combustion facilities and are very costly. The simplest techniques are insufficient to satisfy regulations regarding discharges and cause environmental problems.
A second known route is the development of desulphurization processes, usually with chemical hydroconversion of the sulphur-containing residues, at high hydrogen pressures (typically about 1.2 to 1.8 MPa of H₂ partial pressure), to both partially crack the residues and to reduce their sulphur content. The major processes are hydrotreatment or catalytic hydroconversion of the sulphur-containing residues, carried out in a fixed bed or moving bed or in an ebullated bed or in a slurry depending on the way the catalyst is employed. The term “slurry” as used here describes a suspension of the residue to be treated in the presence of fine particles of catalyst with a mean diameter that is typically less than 100 micrometres, and in the presence of a hydrogen-rich gas. Operating conditions and catalysts for said processes will be described below. This route to the hydrodesulphurization and/or hydroconversion residue is sometimes termed residue hydrotreatment or, mistakenly, referred to as residue hydrocracking (the term hydrocracking should be reserved for high yield conversion of feeds substantially free of asphaltenes or metals over particular bifunctional catalysts) and is a technically powerful route as regards desulphurizing residues to levels of the order of 1.5% by weight of sulphur in the final residue (or in the range 0.5% to 1.25% by weight if suitable processes and conditions are selected) as well as conversion of the residue into distillable products boiling below 565° C., said conversion possibly typically being 20% to 70% if a stable final residue is sought, or higher and even of the order of 95% with slurry processes. The problem with such processes is their high energy consumption linked in part to the high hydrogen consumption. Hydrogen, typically produced in the refinery by reforming naphtha, is insufficient in quantity to carry out both distillate hydrotreatment (in particular of kerosene and gas oil) and residue hydroconversion: vacuum siliconate/deasphalted oil, and primarily residues (containing asphaltenes). Thus, the refinery has to produce the large quantity of hydrogen required for residue hydroconversion. Two main processes for producing hydrogen can be used: partial oxidation of a part of the residues and steam reforming natural gas. Partial residue oxidation is an expensive process and results in the discharge of large quantities of CO₂ into the atmosphere. Natural gas steam reforming is cheaper as regards costs but uses gas, which is an expensive starting material in most refineries. The gas distributed to national networks is typically composed of natural gas supplied by gas pipelines which are often several thousand kilometers long (for example for gas from Russia and distributed into Western Europe) and/or derive from liquefied natural gas transported by cryogenic tankers. Mains gas is thus an expensive fuel the production and distribution of which expends substantial amounts of energy and also results in substantial CO₂ discharge. Residue hydroconversion in the refinery is also difficult to carry out in the majority of low or medium capacity refineries, for example 3 to 8 million tones per annum of oil refining capacity, as the relatively limited quantity of residues does not provide any savings in costs.
The third route for using sulphur-containing refinery residues is to export said residues in the form of high sulphur fuel oil to states in which the regulations regarding discharges from combustion facilities are less severe. Apart from the fact that this constitutes displacement of environmental pollution rather than removal, upgrading residues by exporting is bad because of the unfavorable supply/demand ratio. Further, sulphur-containing fuel oil is transported in special tankers, keeping the temperature at about 70° C. so that the fuel oil can remain pumpable and fluid. Transport is thus expensive and results in high energy consumption and large CO₂ discharges.

Thus, the known routes to using sulphur-containing refinery discharges cause major problems from the environmental viewpoint and/or demand complex, expensive treatment processes.

Apart from the problem with using sulphur-containing residues, the refining industry is also confronted with a further problem, that of an insufficient quantity of middle distillates (kerosene and gas oil) obtained in a conventional refinery compared with market developments, in particular in Europe. In the United States of America, the most sought-after cuts are typically kerosene and usually naphtha cuts suitable for the production of gasoline by catalytic reforming and isomerization.

Another problem in the refinery industry is the discharge of undesirable compounds, whether they are greenhouse gases such as CO₂ or the discharge of sulphur or sulphur-containing compounds. Oil processing and all its principal operations (desulphurized, cracking, etc) produce large quantities of CO₂ and H₂S.

The recovery of CO₂ contained in effluents in particular from oil refineries in developed countries and its transport in liquid form or as a compressed gas for re-injection underground for its sequestration or into depleted oil fields (at the end of working) for assisted oil recovery has already been proposed. Re-injecting H₂S underground has already been proposed. All of those operations have a very high energy cost, not only to capture those gases (for example by amine washing and separating the absorbed gas), but also to transport them in the liquid form or as a compressed gas over distances which may be up to several thousand km if depleted fields in the major producing countries, for example in the Middle East, are to be used.

The various variations and implementations of the invention can overcome or reduce the importance of said problems and has several aspects:

In one aspect, the invention provides a technical solution that can directly or indirectly reduce excess sulphur-containing refinery residues under technico-economic conditions that are favorable compared with known ways of using said residues.

In a further aspect, the invention aims to reduce the energy and environmental costs linked with transporting said excess residues, sources of CO₂ emission and the risk of black tides (if an oil tanker is wrecked).

In a still further aspect, the invention aims to reduce the energy and environmental costs linked to liquefying gas and transporting liquefied natural gas: by using the gas close to the production field for desulphurization and pre-refining crude oil, the quantity of gas that has to be transported to refineries in consumer countries is reduced, thereby reducing associated energy consumption and CO₂ emissions. This aspect is very important, because liquefying gas is complex and expensive. Typically, local field gas use (e. g. as a fuel) is limited and gas has to be transported or converted into a transportable product.

In a further aspect, the invention provides one or more refineries that are compatible, directly or indirectly, with a larger fraction of crude in place on a worldwide level and can thus increase access to a larger quantity of oil which can be extracted from the ground or offshore in the next decades.

In a further aspect, the invention aims to provide direct or indirect access to crude oil at a better price, to more diverse qualities of oil from a wider range of fields, by obtaining regular or long term supply contracts and/or by direct or indirect supply of cargo. Further, linked to the diversification of direct or indirect supply, the invention aims to improve the cost of access to at least some oils by competition between suppliers and/or to reduce relative dependence on light low sulphur crudes the price of which is increasing.

In a further aspect, the invention provides more rational use of energy.

The invention still further aims to provide a technical solution that can reduce the overall discharge of pollutants, in particular greenhouse gases, compared with known alternative routes.

In particular, in accordance with preferred variations, the invention can re-inject, at a very low energy cost, at least a portion of the CO₂ and/or H₂S produced by the pre-refining and the production of hydrogen in depleted fields or aquifers which frequently occur in gas and/or oil production regions.

The invention yet still further aims to provide a technical solution that can benefit a large number or even all refineries regardless of their capacities and their level of excess sulphur-containing residues.

The invention still further aims to directly or indirectly allow an increase in the quantity of middle distillates produced at the refinery, in particular to increase the quantity of high cetane index gas oil bases.

Further aims and advantages of the invention will be described below.

### DESCRIPTION OF THE INVENTION

In order to achieve these aims, the invention proposes the use of a field gas or a purified field gas in the gas production region (and generally also in the region for production of both conventional fluid oil and gas) to produce hydrogen in order to carry out in a facility (I) a treatment of a crude oil or of a hydrocarbon feed comprising a refinery residue, for example a hydrocarbon feed comprising a crude oil and a refinery residue, said treatment comprising at least one catalytic step, carried out over a solid supported hydrotreatment, hydroconversion or hydroconversion catalyst, for at least a fraction of the feed comprising compounds with a boiling point of more than 343° C., usually with a boiling point of more than 371° C. and generally compounds with a boiling point of more than 565° C. to produce at least one pre-refined oil P_{A}. The field gas or purified field gas can also advantageously be used as a fuel in the treatment facility and/or in the hydrogen production facility. Preferably, the treatment is applied or also applied to fractions boiling above 565° C. in a quantity sufficient for the P_{A} vacuum residue to be substantially reduced in % by weight with respect to that of the feed and/or starting oil, for example reduced by at least 20% or 30% or at least 40% or that said residue contains substantially less sulphur and has a sulphur content reduced by at least 20%, or 30% or 40% or more. Preferably P_{A} has no vacuum residue or comprises a vacuum residue that is substantially free of asphaltenes and with a very low sulphur content, typically less than 0.4% and usually 500 ppm by weight, or 300 ppm by weight or less.

Field gas is abundant in many regions of the world and in particular in regions located far from the high consumption zones of Europe, the USA (excluding Alaska) and Japan. In refineries for these principal industrialized countries, the available gas is primarily piped over thousands of km or in the liquefied form; in both cases, the energy costs are high, resulting in high prices. In zones located far from the consumption zones, when it is abundant, the gas is very cheap, often three, four or even ten times cheaper than in the high consumption zones. This very low gas cost can be used in the invention to produce hydrogen at a typically low cost and to use that hydrogen to desulphurize and/or crack heavy oil fractions or refinery residues. Further, using high severity hydrotreatment or hydrocracking of particular heavy fractions, it can be used to produce middle distillates of superior quality and quantity (in particular cetane index or number) and to dope the oil or oils from the treatment into highly upgradable products, in particular kerosene, high cetane index diesel, and possibly high quality reforming feeds for gasoline production.

The hydrogen treatments cited above typically result in a considerable reduction in the quantity of sulphur-containing vacuum residue from effluents or from the residue after subsequent refining, or even, with some treatments, in complete elimination of residues with more than 1% by weight of sulphur. Thus, they can solve the problem of excess sulphur-containing refinery residue, either directly by re-treatment to transform at least part thereof into oil, or indirectly by producing a pre-refined oil that typically has a reduced sulphur-containing residue content. Thus, this can directly or indirectly increase the possibilities of access to crude oil with a wider variation in quality corresponding to a larger proportion of worldwide reserves of crude oil and can thus improve the purchasing conditions for said oil.

Since it is installed on a site that is distinct from a refinery, the pre-refined oil that is produced is not connected with a particular refinery but can be sent under transportation conditions that are substantially the same to different refineries, for example European refineries. Thus, it can supply any refinery, including refineries with small or medium capacities, and those refineries can avoid having to treat residues on an unfavorable scale factor.

All of those improvements are obtained by consuming gas, generally comprising mainly methane, conversion of which for the production of hydrogen emits far less CO₂, a greenhouse gas, than the production of hydrogen by residue gasification. Further, this gas can advantageously be supplied by pipelines without prior liquefaction within its production region. Its use on such a site rather than transporting it to consuming countries that are often 3000 km or more away avoids high energy consumption such as that in recompression stations or gas liquefaction, cryogenic transport and regasification at the methane terminal. Using gas close to its field, compared with the same use (in particular the production of hydrogen for the treatment of residues) results in more rational energy management and can reduce energy consumption and the discharge of greenhouse gases.

In its general form, the invention is applicable to all conventional types of oil and/or refinery residues. The treatment can include the discharge of carbon in the form of coke or it may not include any carbon discharge. However, the invention is preferably employed with a treatment without carbon discharge, readily achieved by selecting a conventional fluid crude which is typically locally transportable in conventional, typically unheated, pipelines.

In accordance with its numerous characteristic variations, the invention has notable advantages as regards the various aims of the invention mentioned above. The terms used (such as field gas, carbon discharge, etc . . . ) are explained below.

The use of oil hydrotreatment processes or hydroconversion processes on the production site or relatively close to the site is already known in the art in the field of the production of oil that is difficult or impossible to transport, such as heavy crude, bituminous crude, etc . . . Such processes can be found in the following American patents: U.S. Pat. No. 3,676,331, U.S. Pat. No. 4,294,686, U.S. Pat. No. 4,347,120, U.S. Pat. No. 5,069,775.

Typically, on-field oil treatment techniques and processes have one main objective: to render a crude oil that cannot be transported or which is difficult to transport capable of being transported. The term “transportable” as used here means transportable by pipeline. Many heavy oils are not liquid at ambient temperature and are not transportable without heating.

Certain techniques are aimed at carrying out a minimal transformation (at minimum cost) so that the treated oil is simply transportable for refining in special refineries.

Other techniques are aimed at obtaining a sufficient improvement to the oil quality for it to be able to be refined in a conventional refinery. A description of such a treatment of heavy Venezuela crude can be found in the “Oil and Gas Journal”, Pennwell Corporation, Tulsa, USA, 16 Jul. 2001, pages 52-55. The treatment described is applied to a viscous heavy crude. It produces coke and a low sulphur content crude that is substantially free of asphaltenes, comprising a diesel cut with a cetane index of less than 42. That treatment is of the “carbon discharge” type as it co-produces coke in large quantities.

Other known treatments comprise another form of carbon removal: the discharge of asphalt (obtained by deasphalting vacuum residue) by combustion, in particular for assisted heavy crude recovery, and/or for the production of hydrogen by partial asphaltene oxidation.

U.S. Pat. No. 5,069,775 cited above also describes a process for hydroconversion of heavy viscous crude oil, typically with a liquid catalyst comprising molybdenum in solution, using natural gas to produce the hydrogen, to produce a fluid crude which is transported to a refinery.

Typically, crude upgrading processes reflect the technical philosophy of oil producers: minimum cost transformation to render the oil:
a) transportable for refining in a special refinery;
b) possibly, for refining in a conventional refinery.

Oilmen are very compartmentalized in an oil company: personnel dealing with refining do not deal with oil production; similarly, oil producers are directly concerned by the fact that their product should be transportable and can be sold to refineries, but are not involved in refining.

Thus, the interest of oil producers in upgrading is typically directly towards elements that affect the oil price: viscosity and pour point (which conditions transport), density (which determines the number of barrels: oil is sold in barrels, not in tonnes) and the sulphur content which affects the price.

Oil is thus considered to be a global substance characterized by its viscosity, its pour point, its density and its sulphur content.

One of the specific aspects of the invention is the use in its different variations of particular feeds and/or treatment steps to achieve particular objectives relative not only to the oil substance but also to its different fractions from a refining viewpoint.

The invention can employ one or more catalytic steps using certain processes that are well known in the art, in particular desulphurizing treatments, under hydrogen, which consume substantial or large quantities of hydrogen:

a) Hydrotreatment (HDT) of asphaltene-free feeds:

Hydrotreatment of hydrocarbon distillates or deasphalted oil (feeds that are substantially free of asphaltenes) are processes that are well known in the art. Their principal aim is to at least partially eliminate undesirable compounds, typically sulphur, nitrogen, and possibly metals such as iron, nickel or vanadium, etc. They are also often used to hydrogenate aromatics, generally simultaneously with feed desulphurization.

Conventionally, for the feeds cited above which include compounds boiling above 371° C., hydrotreatment is a process in which conversion of said compounds into compounds with a boiling point of less than 371° C. is 20% by weight or less. For processes treating the same feeds but with a conversion of more than 20% by weight, we speak of hydroconversion (HDC) or hydrocracking (HDK), those processes being described below.

Hydrotreatment processes function under a pressure of hydrogen and use solid supported catalysts, typically granular solids or extudates with a characteristic dimension (diameter for beads or equivalent diameter (corresponding to the same cross section) for extudates) in the range 0.4 to 5 mm, in particular in the range 1 to 3 mm. The operating conditions, in particular the hourly space velocity (HSV) and the mole ratio of hydrogen to hydrocarbon (H₂/HC) varies depending on the treated cuts, the impurities present and the desired final specifications.

Non limiting examples of types of operating conditions are shown in the table below:

| | | space | H₂ | start cycle | H₂/HC | H₂ |
|---|---|---|---|---|---|---|
| | cut point | velocity | pressure | temperature | ratio | consumption |
| oil cut | (° C.) | (h⁻¹) | (bar) | (° C.) | (Nm³/m³) | (wt %) |
| naphtha | 70-180 | 4-10 | 5-10 | 260-300 | 100 | 0.05-0.01 |
| kerosene | 160-240 | 2-4 | 15-30 | 300-340 | 150 | 0.01-0.02 |
| diesel & | 230-371 | 1-3 | 20-40 | 320-350 | 150-300 | 0.3-0.8 |
| gas oil | | | | | | |
| vacuum gas | 371-565 | 1-2 | 40-70 | 360-380 | 300-500 | 0.4-0.9 |
| oil | | | | | | |
| deasphalted | >565 | 0.5-1.5 | 50-110 | 360-380 | 500-1000 | 0.5-1 |
| oil | | | | | | |

Hydrotreatment catalysts typically comprise a metal or compound of a metal from group VIB and a metal or compound of a metal from group VIII on a support.

Usually, the catalysts are composed of an oxide support and an active phase in the form of molybdenum sulphide or tungsten sulphide promoted by cobalt or nickel. Usually, the catalysts are CoMo, NiMo and NiW combinations as the active phase and large specific surface area γ alumina as the support. The metal contents are usually of the order of 9% to 15% by weight of molybdenum and 2.5% to 5% by weight of cobalt or nickel.

Some of these catalytic formulae may sometimes be doped with phosphorus. Other oxide supports are used, such as mixed silica-alumina or titanium-alumina oxides.

Said supports are typically of low acidity to obtain acceptable catalytic cycle times.

Examples of catalysts for hydrotreatment of diesel, gas oil or vacuum gas oil cuts are HR448 and HR426 from AXENS.

When traces of metals, in particular nickel and vanadium, are present in the feed, then advantageously the catalytic support used has a porosity that is adapted to deposition of those metals.

One example of such a catalyst is HMC 841 from AXENS.

When hydrotreating a deasphalted oil (DAO) comprising metals, a first bed with catalyst HMC 841 can be used for demetallization, for example, then a second bed of HR448 for desulphurization and denitrogenation.

Other technical elements relative to hydrotreatments can be found in the reference work “Conversion processes” by P Leprince, Editions Technip, Paris 15^{th}, pages 533-574.

b) Processes for hydrocracking (HDK) asphaltene-free feeds Hydrocracking processes are also well known in the art. They apply exclusively to feeds that are substantially free of asphaltenes or metals such as nickel or vanadium.

The hydrocracking feed is typically composed of vacuum gas oil, sometimes supplemented with gas oil and/or deasphalted oil (deasphalted vacuum residue, typically deasphalted using a solvent from the group formed by propane, butane, pentane and mixtures thereof, preferably propane and butane).

Deasphalted oil (often termed DAO) can also be hydrocracked. The DAO must be of a sufficient quality: typically, a hydrocarbon feed comprises less than 400 ppm (parts per million by weight) of asphaltenes, preferably less than 200 ppm and more preferably less than 100 ppm. The metals contents (typically nickel+vanadium) of a hydrocracking feed are typically below 10 ppm, preferably below 5 ppm, and more preferably below 3 ppm.

Conventionally, a feed is considered to be substantially asphaltene-free if its asphaltenes content is below 400 ppm.

Typically, the hydrocracking feed is initially pre-refined over a hydrotreatment catalyst, typically different from the hydrocracking catalyst. That catalyst, which typically has an acidity that is lower than that of the hydrocracking catalyst, is selected to substantially eliminate metals, reduce traces of asphaltenes and reduce organic nitrogen, which inhibits hydrocracking reactions, to a value that is typically below 100 pm, preferably 50 ppm and more preferably below 20 ppm.

Hydrocracking catalysts are typically bifunctional catalysts with a dual function: acid and hydrogenating/dehydrogenating.

Typically, the acidity of the support is relatively high so that the ratio of the hydrogenating activity to the isomerising activity, H/A, as defined in French patent FR-A-2 805 276 pages 1 line 24 to 3 line 5, is more than 8, or preferably more than 10, or more preferably more than 12, or even more than 25. Typically, hydrotreatrnent is carried out upstream of the reactor or the hydrocracking zone with a hydrotreatment catalyst with a H/A ratio of less than 8, in particular less than 7.

Hydrocracking catalysts typically comprise at least one metal or compound of a metal from group VIB (for example Mo, W) and a metal or compound of a metal from group VIII (for example Ni . . . ) deposited on a support. The atomic ratio of the group VIII metal (M_{VIII}) to the sum of the group VIII and VI metals, i.e., the atomic ratio M_{VIII}/(M_{VIII}+M_{VIII}), in particular for NiMo and NiW pairs, is usually close to 0.25, for example in the range 0.22 to 0.28.

The metals content is usually in the range 10% to 30% by weight.

The group VIII metal can also be a noble metal such as palladium or platinum, in amounts of the order of 0.5% to 1% by weight.

The acid support may comprise an alumina doped with a halogen or a silica-alumina with sufficient acidity, or a zeolite, for example a Y zeolite or dealuminated USY zeolite, usually with a double pore distribution with a double pore framework comprising micropores with a dimension principally in the range 4 to 10 Å and mesopores with a dimension principally in the range 60 to 500 Å. The silica/alumina ratio in the zeolite structure is usually in the range 6.5 to 12.

By way of example, it is possible to use a hydrotreatment and hydrocracking combination with catalysts HR 448 (HDT) then HYC 642 (HDK) sold by AXENS. If the feed includes metals, then a bed of a demetallization catalyst such as HMC 841 from AXENS can be used upstream of said two catalytic beds.

Typical operating conditions for hydrocracking are:
hourly space velocity HSV between 0.3 and 2 h⁻¹;
temperature between 360° C. and 440° C.;
hydrogen recycle between 400 and 2000 Nm³ per m³ of feed;
the partial pressure of hydrogen and total pressure can vary substantially depending on the feed and the desired conversion. By convention, a conversion of 20% by weight or more and less than 42% by weight corresponds to mild hydrocracking (M-HDK); a conversion of 42% or more and less than 60% by weight corresponds to medium pressure hydrocracking (MP-HDK); a conversion of 60% or more (and typically less than 95% by weight) corresponds to high pressure hydrocracking (HP-HDK).

By definition, the conversion is that of products with a boiling point of more than 371° C. to products boiling below 371 ° C.

Typically, depending on the feeds, the partial pressure of hydrogen is usually in the range about 2 MPa to 6 MPa for mild hydrocracking, between about 5 MPa and 10 MPa for medium pressure hydrocracking, and between about 9 MPa and 17 MPa for high pressure hydrocracking. The total pressure is usually between 2.6 and 8 MPa for mild hydrocracking, between about 7 and 12 MPa for medium pressure hydrocracking, and between 12 and 20 MPa for high pressure hydrocracking.

Hydrocracking processes are typically operated in fixed bed mode with granular solids or extrudates with a characteristic dimension (diameter for beads or equivalent diameter (corresponding to the same cross section) for extrudates) in the range 0.4 to 5 mm, in particular in the range 1 to 3 mm. The scope of the invention also encompasses hydrocracking being carried out in a moving bed (granular bed of catalyst typically in the form of extrudates or, preferably, beads, with dimensions similar to those described for a fixed bed).

Other technical elements relating to hydrocracking can be found in the reference text “Hydrocracking Science and Tecluiology”, J Scherzer and A J Gruia, Publishers Marcel Dekker, New York, and in the reference work “Conversion processes” by P Leprince, Editions Technip, Paris 15^{th}, pages 334-364.

c) Processes for hydroconversion (HDC) of an asphaltene-free feed (for example of the DAO type) but comprising large quantities of metals (Ni, V):

Such processes are known and can achieve conversions (as defined for hydrocracking) that are more than 20% by weight and frequently much higher (for example 20% to 50%, or 50% to 85% by weight), for example ebullated bed processes. Said processes can employ different hydrogen partial pressures, for example between 4 and 12 MPa, temperatures between 380° C. and 450° C., and a hydrogen recycle that is between 300 and 1000 Nm³ per m³ of feed.

The catalysts used are similar or close to those used for hydrotreatment or residue hydroconversion, described below, and their porosity is such as to allow a large demetallization capacity.

As an example, it is possible to use a HTS358 type catalyst sold by the French company AXENS.

d) Residue hydrotreatment (RHDT) or residue hydroconversion (RHDC):

Residue hydrotreatment processes (and residue hydroconversion processes) are well known in the art.

Typical operating conditions for these processes are: an hourly space velocity (HSV) in the range 0.1 to 0.5; a partial pressure of H₂ in the range 1 to 1.7 MPa; a hydrogen recycle in the range 600 to 1600 Nm³ per m³ of feed; a temperature in the range 340° C. to 450° C.

The catalysts for fixed, moving or ebullated bed processes are usually macroscopic supported solids, for example beads or extrudates with a mean diameter in the range 0.4 to 5 millimetres. They are typically supported catalysts comprising a metal or compound of a metal from group VIB (Cr, Mo, W) and a metal or compound of a metal from group VIII (Fe, Co, Ni. . . . ) on a mineral support, for example catalysts based on cobalt and molybdenum on alumina, or nickel and molybdenum on alumina.

By way of example, for fixed bed hydrotreatment or hydroconversion, a hydrodemetallization catalyst HMC 841 can be used, then hydroconversion and hydrocracking catalysts HT 318 then HT 328 sold by AXENS. For an ebullated bed, a catalyst of the HOC 458 type, also sold by AXENS, can be used. Catalysts for slurry processes are more diversified and can include coal or ground lignite particles impregnated with iron sulphate or other metals, ground used hydrotreatment catalysts, particles of molybdenum sulphide associated with a hydrocarbon matrix obtained by in situ decomposition of precursors such as molybdenum naphthenate, etc . . . The particle dimensions are typically less than 100 micrometres, or much less.

Other characteristics of the processes and residue hydroconversion catalysts are given in general reference text A: “Raffinage et conversion des produits lourds du pétrole” [Refining and Converting Heavy Oil Products] by J F Le Page, S G Chatila, M Davidson, Editions Technip, Paris, 1990, in chapter 4 (Conversion catalytique sous pression d'hydrogene) [catalytic conversion under hydrogen] and chapter 3, paragraph 3.2.3. Reference can also be made to the general reference text B: Book 3: Conversion processes, by P Leprince Editions Technip, Paris 15^{th}, pp 411-450, 1998, in chapter 13 (hydroconversion des résidus) [residue hydroconversion] and the general text: “Upgrading petroleum residues and heavy oils”, Murray R Gray, published by Marcel Dekker Inc, New York, Chapter 5.

The production of hydrogen from purified gas, for example by steam reforming over a nickel catalyst then steam conversion of CO then purification, is a known process described in reference B cited above, pp 451-502, or in the reference text “The desulphurization of heavy oils and residues”, J Speight, published by Marcel Dekker, Inc, New York.

In a preferred variation of the invention, a field gas or a purified field gas G is used in the gas production region as follows:
a) at least a fraction G1 of the gas G is converted to obtain a stream of hydrogen (H₂);
b) a conventional fluid crude oil P1 with a pour point of 0° C. or less is selected and supplied by pipeline and/or oil tanker, P1 comprising a vacuum residue with a sulphur content above 1% by weight;
c) a treatment is carried out on said hydrocarbon feed comprising oil P1 in a hydrocarbon treatment facility (I), carried out substantially without carbon discharge, and comprising:
   at least one desulphurizing treatment step by hydrotreatment (HDT, RHDT) or hydro conversion (HDC, RHDC) or hydro cracking (HDK) of at least a fraction of the oil P1, said fraction primarily comprising compounds with a boiling point of more than 343° C. (majority of compounds), said step using at least a fraction of the H₂ stream;
   at least one step, which may be common with or separate to the desulphurizing treatment step, for reducing the quantity of vacuum residue in the oil P1, by segregation and/or conversion of a portion of said vacuum residue, for example by segregation of the asphalt produced by deasphalting;
      to produce at least one pre-refined oil P_{A} comprising compounds derived from the desulphurizing treatment step, said pre-refined oil having a reduced sulphur content of at least 50% or even 90% or more with respect to the oil P1, and a vacuum residue with a sulphur content of more than 1% by weight which is zero or reduced by at least 15%, preferably by at least 50% or even 90% or more with respect to the oil P1;
d) and said pre-refined oil P_{A} is evacuated to an oil port for refining in a distinct refinery distant from the facility (I).

Typically, the selected oil P1 is a conventional transportable conventional crude oil supplied via an unheated pipeline or unheated oil tanker.

The invention can produce an oil with a greatly reduced sulphur content containing a lower or zero quantity of sulphur-containing vacuum residue. Refining said oil in refineries with excess sulphur-containing fuel can produce the same quantity of refined products with a smaller quantity of oil, with a lower energy consumption and co-production of CO₂, H₂S and sulphur-containing residue. Said aims are accomplished by using a field gas which does not have to be transported thousands of km, nor does it have to be liquefied, which is advantageous both from the energetic point of view and as regards the discharge of CO₂. All of these elements can accomplish the essential aims of the invention.

In a variation, considered to be the preferred variation, total segregation of said vacuum residue or of at least the asphaltenes in said vacuum residue is carried out to produce a pre-refined oil P_{A} which is substantially free of asphaltenes and at least one segregated fraction comprising at least the major portion of the asphaltenes, optionally cracked and/or supplemented with other fractions of P1, in the form of a heavy liquid fuel or a residual oil P_{B}. The fraction of oil P_{A} boiling above 343° C. is then generally a desulphurized fraction with a sulphur content of less than 1% by weight, derived from said desulphurizing treatment (HDC, HDT, HDK). Said segregation is very different from that carried out in the prior art in which asphaltenes are converted into solid coke (difficult to transport and upgrade) in a cokefaction unit. In accordance with the invention, a residual oil is an oil which is liquid at ambient temperature, comprising a vacuum residue which contains asphaltenes. Typically, the major portion of the asphaltenes and generally all of them is thus segregated in a liquid product PB which is easy to transport and upgrade.

This variation of the invention enjoys particular major advantages: in fact, the refined oil, being free of asphaltenes, can subsequently be converted by conventional refining with very low or zero co-production of sulphur-containing residue. There is then no more downstream transport of sulphur-containing residue, and the refinery can function with a minimum quantity of feed; the same is true for CO₂ and H₂S discharges.

The residual oil P_{B} can be sent directly into regions of the world where the market for heavy products is small or where heavy fuel can be used as a substitute for coal. This all contributes to reducing the movements of oil products, in particular heavy residues, and thus reduces the risk of black tides and energy consumption and corresponding emissions of CO₂. Further, all of the residue from oil P1 including the asphaltenes is typically stored in liquid form (heavy fuel and/or oil P_{B}) and not degraded to coke.

In accordance with one implementation of the invention:
at least an atmospheric distillate, a vacuum distillate and a vacuum residue are produced by atmospheric and vacuum distillation of the oil P1;
at least a portion of said vacuum residue is deasphalted to obtain a deasphalted oil and asphalt;
said desulphurizing treatment (HDC, HDT, HDK) is carried out on the vacuum distillate and deasphalted oil, separately or as a mixture, to obtain an effluent with a sulphur content of less than 1% by weight;
said pre-refined oil P_{A} which is substantially free of asphaltenes and comprises no vacuum residue with a sulphur content of more than 1% by weight is reconstituted from at least a portion of the effluents from said desulphurizing treatment and at least a portion of the atmospheric distillate.

This implementation can desulphurize a maximum amount of non residual cuts: vacuum distillate and deasphalted oil. Further, advantageously, a desulphurizing treatment with considerable conversion of the treated heavy feed (30% by weight, 50%, or more) can be used. This is applicable not only for the stated implementation but also for all of the implementations of the treatment for implementing the invention. The conversion of heavy products thus considerably reduces the overall quantity of remaining vacuum residue. The HDS desulphurizing treatment can advantageously be hydrocracked in an ebullated bed under a pressure in the range 5 to 12 MPa, for example.

It is also possible to carry out the following steps:
at least an atmospheric distillate and a vacuum distillate and a vacuum residue are produced by atmospheric and vacuum distillation of the oil P1;
at least a portion of said vacuum residue is deasphalted to obtain a deasphalted oil and asphalt;
a residual oil PB is produced, comprising at least the major portion of the asphalt obtained and a limited quantity of relatively lighter fractions so that the asphaltenes content of the vacuum residue of the oil P_{B} is greater than that of the vacuum residue of the oil P1 by at least 20%, said content preferably being greater than 12% by weight or even more than 14% by weight.

In accordance with a first technical option, said relatively lighter fractions derive from treatment of the oil P1 and comprise a portion of the effluents from said desulphurizing treatment.

In accordance with another technical option, said relatively lighter fractions are principally composed by crude oil.

This concentration of asphaltenes in a reduced quantity of vacuum residue has a double advantage: it can reduce the overall quantity of residue; it can also increase the asphaltenes content of the residue (in particular when advantageously starting from a content of less than 10% by weight), and very generally to improve the quality of said residue as a base for road asphalt.

The use of crude oil to dilute the asphalt is an interesting option as it allows to keep all of the desulphurized deasphalted oil in a non residual oil P_{A}, which allows most of it to be converted subsequently (during refining) into noble products by hydrocracking or fluidized bed catalytic cracking. Thus, this is favourable from the point of view of refining efficacy and thus of energy consumption and CO₂ discharge.

If, in contrast, said desulphurized deasphalted oil is re-mixed with a residual cut, upgradable fractions left in the vacuum residue during subsequent refining are lost.

In accordance with a further implementation of the invention:
at least an atmospheric distillate, a vacuum distillate and a vacuum residue are produced by atmospheric and vacuum distillation of the oil P1;
the vacuum residue is converted by catalytic hydroconversion (RHDC), one or more fractions from the oil P1 optionally being added to the effluents from said catalytic hydroconversion to produce the residual oil PB.

This implementation, which involves higher costs, can substantially reduce asphaltenes by catalytic hydroconversion (RHDC) and result in an ultimate desulphurization of the residue to below 1% by weight of sulphur.

In a further implementation of the invention:
at least an atmospheric distillate and an atmospheric residue are produced by atmospheric distillation from the oil P1;
the atmospheric residue is converted by catalytic hydroconversion (RHDC);
at least a portion of the effluents from said catalytic hydroconversion are fractionated into one or more non residual fractions to form the refined oil P_{A} by mixing, after adding at least a portion of said atmospheric distillate, optionally desulphurized, and adding the complementary portion of the effluents from treating the oil P1 is added to produce the residual oil P_{B}. This implementation, which costs more, is an alternative which can also very substantially reduce the asphaltenes by catalytic hydroconversion (RHDC) and result in an ultimate desulphurization of the residue to below 1% by weight of sulphur.

It is also possible to carry out the following steps:
at least an atmospheric distillate, a vacuum distillate and a vacuum residue are produced by atmospheric and vacuum distillation of the oil P1;
said vacuum residue is deasphalted to obtain a deasphalted oil and asphalt;
said desulphurizing treatment (HDC, HDT, HDK) is carried out on the vacuum distillate and the deasphalted oil, used alone or as a mixture, to obtain an effluent with a sulphur content of less than 1% by weight;
said pre-refined oil P_{A}, substantially free of asphaltenes and comprising no vacuum residue with a sulphur content of more than 1% by weight, is reconstituted from at least the major portion of the effluents from said desulphurizing treatment and atmospheric distillate;
the major portion or, as is preferable, all of the asphalt is burned, preferably fluxed, as a fuel for the facility (I) and/or for a power station and/or for a seawater desalination plant.

Combustion of asphalt, typically fluxed and in the form of a heavy fuel, when carried out to extinction, can advantageously eliminate the least upgradable compounds and produce a single pre-refined oil PA which is substantially free of asphaltenes and comprises no vacuum residue with a sulphur content of more than 1% by weight, i.e. a high value oil, subsequent refining of which can be carried out without producing high sulphur content residues with a reduced energy consumption and limited CO₂ and H₂S emissions.

In accordance with a further additional category of variations, the invention can also bring essential additional advantages from the environmental viewpoint:

In accordance with a first additional variation, at least a portion of the CO₂ co-produced during conversion of gas G1 to hydrogen is recovered and said CO₂ is injected underground into the gas production region close to the facility (I).

As already mentioned, the most suitable regions for implementing the invention are gas-bearing regions, and also oil-bearing regions. Thus, said regions very generally have many underground storage possibilities: oil, gas, condensate gas-depleted fields, aquifers. These are highly suitable for sequestrating CO₂ and/or H₂S. Further, it is easy to recover the CO₂, for example by amine washing, from a synthesis gas for the production of hydrogen (typically after steam reforming the gas and steam converting the CO (carbon monoxide)). This gas is typically produced under high pressure such as between 2 and 5 MPa. Recovering H₂S during desulphurization operations under substantial or high pressure is also easy.

In accordance with one option, CO₂ is injected into an oil and/or gas field, for example into an oil field, in particular a depleted field to obtain assisted oil recovery.

It is also possible to inject the CO₂ into a field which is depleted in oil or gas to obtain CO₂ sequestration.

In accordance with a second additional variation, at least a portion of the H₂S co-produced during the desulphurization step is recovered and injected underground into the gas production region close to facility I, for example into an aquifer, to sequestrate said H₂S. Finally, H₂S and CO₂ can be injected together to sequestrate them.

CO₂ and/or H₂S can be injected in liquid form or in gas form at high pressure (for example between 5 and 400 MPa).

According to the invention, there is a strong synergistic effect between pre-refining and CO₂ and H₂S sequestration (or assisted recovery). The gas is locally converted into hydrogen in the gas production region in zones where unwanted gas (CO₂, H₂S) can be re-injected underground. This production generates CO₂ as an undesirable co-product, and the desulphurizing treatment (in hydrogen) generates H₂S as another unwanted product. Part or all of these unwanted gases are typically injected underground to sequestrate them.

In accordance with the invention, only a conventional fluid crude oil or a mixture of conventional fluid crude oils is treated in the facility (I) rather than a heavy oil which is difficult to transport or cannot be transported without fluxing and/or heating.

A conventional fluid oil (defined below) has intrinsic characteristics which classify it as a readily transportable oil. Its viscosity is low. Its pour point is less than 0° C., normally less than −10° C., usually less than −12° C., typically less than −14° C. and sometimes less than −16° C. or −18° C., or even less than −20° C.

Carrying out a pre-refining treatment on said oil, which has already been transported by pipeline (like a conventional oil, i.e. without dilution/separation/recycle of a diluent as is sometimes the case when transporting heavy crudes or heavy oils) or which has already been transported by oil tanker, is surprising as said oil can readily be sent directly to an oil refinery. While viscous heavy oil upgrading techniques (or techniques for treating oil with pour points of more than 0° C.) can theoretically be applied to such a conventional crude, there is no motivation for such a treatment compared with direct transmission of said oil to the refinery for the person skilled in oil production. The person skilled in oil production would typically seek to carry out the minimum amount of treatment for the oil to be transportable and saleable.

The above can be discerned from a number of patents, for example U.S. Pat. No. 5,069,775 cited above. The described process is said to be applicable to crudes that may have an API density in the range −5 to 35, which includes relatively light oils, but does not state that said oils include readily transportable oils. Light oils are known that have an API density of more than 30 and which have a pour point at a positive temperature, and can cause substantial problems as regards transport. By way of examples, the Libyan “Es Sider” oil has an API density of 37 and a pour point of +7° C., “Gamba” and “Mandji Blend” crudes from Gaboon have an API density of 31.4 and 30.1 respectively, but have pour points of 32° C. and 9° C. respectively. In contrast, that patent indicates that the field of the invention is upgrading viscous heavy crudes, and that the process is particularly suitable for the treatment of heavy oils and residual oils. The first claim of that patent defines a treatment “to obtain a fluid oil then transport said oil to a refinery at least by transport using a pipeline”. The treatment is only carried out on a fraction of the initial oil, to carry out the minimum treatment sufficient to ensure the fluidity of the resulting oil. The only parameter mentioned for the oil is its viscosity, and the composition of the oil produced or the properties of its fractions are not mentioned. The catalyst used is a liquid additive to minimize the cost of the treatment (typically, said processes are cheaper than processes using solid macroscopic supported catalysts, but are less efficient as regards desulphurization).

The use of low value methane for producing hydrogen is mentioned, but does not appear to be a motivation for the treatment, but simply as an accompanying technical means that is advantageously usable in the context of a plan for producing oil that is difficult to transport. That patent is fairly characteristic of the technical and economic philosophy of oil production personnel who seek a commercializable oil using simple means, at a minimum cost, characteristics of field operations.

For a conventional oil that is fluid and has a low pour point, the technical logic is to carry out refining directly in a conventional refinery and not to break the chain to produce an intermediate oil that has to be transported again for refining in an oil refinery.

In contrast, in accordance with the present invention, we have discovered that with respect to the desired objectives, treatment of a conventional fluid oil transported with no diluent enjoys important advantages compared with traditional upgrading of a heavy crude oil that is difficult to transport:
simulations and modeling of facilities for different feeds and residue treatment processes have shown that, surprisingly, with a view of producing a given quantity of improved oil with reduced excess sulphur-containing fuel during subsequent refining, the necessary costs are is substantially lower for a conventional crude. This arises from different reasons which are often combined:
heavy crudes are typically immature crudes containing large quantities of vacuum residue and generally very high metals contents (Ni, V) which greatly reduce the activity of supported catalysts;
the typically highly aromatics composition of a crude oil produces, after hydroconversion, diesel fractions with a fairly low cetane index, typically less than 49, and usually less than 45 or 42, which would be difficult and expensive to improve to transform them into diesel fuel bases;
further, heavy crudes often comprise a vacuum gas oil in a limited quantity with respect to the vacuum residue. We have discovered that the quantity of vacuum gas oil or vacuum gas oil supplemented with deasphalted oil is an important parameter in an upgrading scheme on a technical and economic front. Said deasphalted cuts are actually precursors for highly upgradable products which can be converted at lower cost than a vacuum residue;
the amount of asphaltenes in the vacuum residue, often very high with heavy crudes, has also turned out to be an important parameter, in particular as regards possible treatment schemes;
further, the production of a heavy crude and its routing to the treatment facility results in high costs and energy expenditure.

Typically, a conventional fluid crude oil of the invention is selected, with a weight ratio J=(GO+VGO)/(GO+VGO+R) of more than 0.45, in particular more than 0.50, preferably more than 0.54, or even 0.58 and highly preferably more than 0.62. Conventionally, GO represents the percentage by weight (between 0 and 100) with respect to the oil of the oil fraction boiling (using TBP distillation, true boiling point) between 343° C. and 371° C. VGO represents the percentage by weight of the oil fraction boiling between 371° C. and 565° C. and R is the percentage by weight of the vacuum residue (boiling at a temperature of 565° C. or more) in said oil. The parameter J is an indicator of the percentage of heavy fractions that is not residual.

The parameter H=VGO+R(100−2×As)/100 in which As is the weight (number between 0 and 100) of asphaltenes in the vacuum residue, is also important. That parameter is an indicator of the non asphaltene oily heavy fraction that can be upgraded more easily. Preferably, H is over 35, in particular over 0.38, preferably more than 0.41 and highly preferably more than 0.45.

The conventional fluid crude oil preferably also has an asphaltenes content As in its vacuum residue of less than 11% by weight, or 10% by weight, or less than 9% by weight, usually less than 8% by weight and highly preferably less than 7% by weight. This amount is correlated with the difficulty in treating a vacuum residue, linked to the asphaltenes content.

This allows large quantities of deasphalted oil DAO to be extracted; it can be upgraded using said desulphurizing treatment, and can strongly concentrate the asphalt to produce a crude oil containing quantity bitumen bases, for example.

The asphaltenes content of the selected conventional fluid oil itself (and not its residue) is also often less than 5% by weight and preferably 3.3% by weight and highly preferably less than 2.2% by weight.

Preferably, an oil P1 is selected in which the quantity of metals (Ni+V) in the vacuum residue is less than 800 ppm by weight, in particular less than 700 ppm or than 550 ppm or than 400 ppm or than 300 ppm or than 200 ppm and preferably less than 150 ppm by weight or even than 100 ppm, and highly preferably less than 80 ppm.

Further variations of the invention will now be described; they can advantageously be used with conventional fluid oils. Technically speaking, these variations can also be used with any other type of oil, including heavy oils, and also with oil residues.

In a further variation of the invention, a treatment is carried out that comprises:
an initial step comprising fractionation to obtain a fraction F that is substantially free of asphaltenes and mainly comprises compounds with a boiling point of more than 371° C.;
at least one hydroconversion step (HDC) or hydrocracking step (HDK) carried out on at least a portion of the fraction F, with conversion of compounds with a boiling point of more than 371° C. of at least 42% by weight, normally more than 52% by weight, for example more than 60% by weight.

Preferably, a sufficient hydrocracking pressure is selected (to increase the cetane index and cetane number of the distillates produced), a sufficient fraction of hydrocracking effluents is incorporated into the fractions composing the pre-refined oil P_{A} and optionally, a straight run diesel fraction directly from P1 is incorporated into P_{A} after hydrotreatment (HDT) at a sufficient pressure so that the pre-refined oil P_{A} comprises a diesel fraction with a cetane index of at least 48, or 49, or 50, usually at least 51 or even 52. Preferably, in particular if the oil P_{A} is intended for the European market, the cetane index of the diesel fraction of said oil is more than 51, for example in the range 52 to 70.

Such a use of hydrocracking, in particular hydrocracking at medium or high pressure, is surprising in an upgrading scheme: a hydrocracker is a “top of the range” unit, often the most expensive unit in the refinery, and only a few refineries have one. The feature of hydrocracking in a refinery is the production of diesel and/or kerosene and/or oil base cuts of very high quality. This is typically foreign to the upgrading philosophy of the prior art.

### Variations in Treatment W ith Deasphalting

In a further characteristic variation of the invention, a deasphalting step is carried out on at least a portion of the vacuum residue of the hydrocarbon feed or crude P1 to obtain a stream of deasphalted oil DAO and a stream of asphalt As, and at least a portion of said As stream is mixed with at least one mixing hydrocarbon stream typically derived directly from the feed or after at least partial treatment(s) to produce (after any separation of certain fractions of the mixture) a reconstituted oil or refined oil.

In one particular disposition:
a) The mixing conditions, and in particular the relative quantity of the mixing stream compared with the quantity of asphalt As and the composition of the mixing stream, are selected so that the vacuum residue of said reconstituted or refined oil has an asphaltenes content that is substantially higher than that of the vacuum residue supplied to the deasphalting unit.

The vacuum residue of the reconstituted oil can have an increased asphaltenes content of at least 18% with respect to the asphaltenes content of the vacuum residue sent for deasphalting, often increased by at least 22%, or even at least 26%, preferably at least 30% and highly preferably at least 35% compared with the amount of asphaltenes in the initial vacuum residue.

Typically, the crude oil A1 and/or the hydrocarbon feed are selected so that the asphaltenes content of the initial vacuum residue, for example the vacuum residue of crude A1 or that of the feed, is less than 12% by weight, often less than 11% by weight, preferably less than 10% by weight or 8% by weight and highly preferably less than 7% by weight, for example in the range 0.5% to 6.5% by weight.

The asphaltenes content of the vacuum residue of the reconstituted crude can, depending on the case, be more than 8% by weight, generally than 10% by weight, usually more than 11% by weight. Preferably, it is in the range 12% by weight to 25% by weight, and highly preferably in the range 13% by weight to 20% by weight. Thus, a large concentration of asphaltenes is produced, which reduces the volume of sulphur-containing residue.

The vacuum residue sent for deasphalting may comprise compounds that have undergone cracking, for example thermal cracking under hydrogen or hydrotreatment. Typically, and preferably, said vacuum residue is a virgin residue comprising virgin asphaltenes at least the majority or all of which have not undergone a chemical treatment or prior cracking operation.

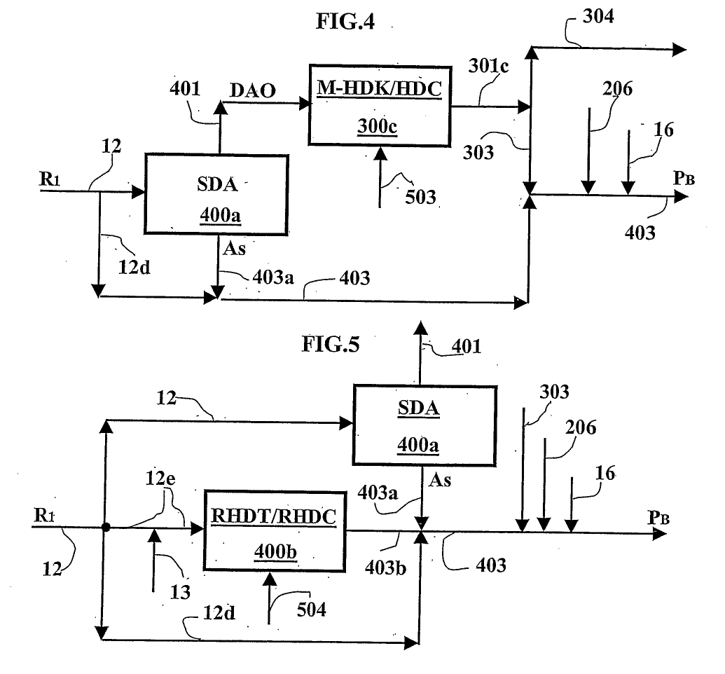

The mixing stream advantageously comprises a fraction with a sulphur content that is substantially reduced compared with that of the initial DAO, for example all or part of the DAO itself, after hydrotreatment and/or hydroconversion and/or hydrocracking, in a fixed, moving or ebullated bed, as described with respect to FIG. 4. It can also comprise a portion of the initial vacuum residue, or a stream of crude oil (or a fraction of crude oil), in particular if said crude oil has a vacuum residue with an asphaltenes content of less than 11%, or 10%, or 9% or preferably 8% and highly preferably 7%. Typically, the mixing stream or streams comprise a vacuum residue with a sulphur content of less than 1.25% by weight, or than 1% by weight and preferably less than 0.8% or even less than 0.6% by weight. Said reconstitution of an oil with a concentration of asphaltenes can be carried out on all or part of a vacuum residue fraction of the feed or oil P1.

Said residue treatment scheme is described in FIG. 4.

In a particular variation of the invention, described in FIG. 5, treatment of residue R comprises deasphalting (SDA) a portion of the residue, hydrotreatment (RHDT) or hydroconversion (RHDC) of a further portion of the residue, and mixing at least a portion of the asphalt from deasphalting and at least a portion of the hydrotreatment or hydroconversion effluent to obtain a pre-refined oil P_{B}. Said pre-refined oil can also comprise a portion of the initial residue and/or a further crude or a fraction of a further crude. This treatment scheme is advantageous when the initial vacuum residue or the vacuum residue fraction of the residue R has a relatively high asphaltenes content such as 8% by weight to 20% by weight or 9% by weight to 18%, in particular 10% by weight to 18% by weight or 11% by weight to 16% by weight and typically 12% by weight to 16% by weight. In this case, asphaltenes reduction by hydroconversion can concentrate other asphaltenes without becoming too high. The proportion of hydroconverted residue is, for example, in the range 15% to 75% by weight, often in the range 20% to 65% by weight.

In a farther characteristic variation of the invention, the hydrocarbon treatment facility (I) of the invention produces at least two separate oils P_{A} and P_{B}, typically intended to be sent separately to one or more oil refineries by pipelines and/or oil tanker.

In general, said two oils are intended to be transported separately by oil tankers over distances exceeding 1000 km or even 1500 km and generally to different refineries.

By using different compositions for the two oils, this can improve their overall upgradability. Thus, for example, an oil that is rich in kerosene generally has high upgradability in the USA; an oil that is rich in diesel with a high cetane index or number generally has high upgradability in Europe while that characteristic is less important in the USA.

An oil comprising a sulphur-containing vacuum residue in large quantities is generally more readily upgradable in the Far East than in Europe.

Typically, one of the two oils differs from the other by at least 10%, usually 15% and generally 20% in at least one of the following parameters: the percentage by weight of kerosene, the percentage by weight of diesel, the percentage by weight of vacuum residue containing more than 1.25% by weight of sulphur.

Generally, one of the two oils comprises a diesel cut with a cetane index CI which is higher by at least 2 points, usually 3 points and generally 4 points than that of the other oil.
In a first implementation, one of the two oils P_{A} is free of vacuum residue containing more than 1.5% by weight of sulphur, usually free of residue containing more than 1.25% by weight of sulphur or even more than 1% by weight, or preferably more than 0.8% by weight of sulphur, while the other oil P_{B} comprises a vacuum residue with a sulphur content SRB of more than 1.25% by weight, and typically more than 1.5% by weight. P_{A} can comprise a vacuum residue with a sulphur content of 1% or less.
In a particular implementation of the above mode, oil P_{A} is an oil that is substantially free of asphaltenes (less than 400 ppm conventionally) or even of vacuum residue with a boiling point of 565° C. or more. If P_{A} comprises a vacuum residue, it typically has a sulphur content SRA of less than 0.4% by weight, usually less than 0.2% by weight, for example less than 0.1% by weight or less than 100 ppm by weight.

The ratios of the percentages by weight of the two oils in kerosene and/or diesel cut then satisfies one or more of the following inequalities:
K_{A}/K_{B}>1.1 (or 1.15 or 1.2 or 1.3 or 1.4)
D_{A}/D_{B}>1.1 (or 1.15 or 1.2 or 1.3 or 1.4)
CI_{A}-CI_{B}>2 (or 3 or 4 or 5)

In which K_{A} and K_{B} designate the percentages by weight of kerosene in oils P_{A} and P_{B}, D_{A} and D_{B} represent the percentages by weight of diesel in oils P_{A} and P_{B}, and CI_{A} and CI_{B} represent the cetane indices of the diesel in oils P_{A} and P_{B}.

This difference in the cetane index can be obtained by incorporating into crude P_{A} a relatively larger quantity of hydrocracking diesel, in particular high pressure hydrocracking, when facility (I) includes a hydrocracker. It can also be obtained by incorporating into crude P_{A} a diesel cut that has been hydrotreated more severely, for example at a lower hourly space velocity (HSV) or at a higher pressure. The weight ratio between the oil P_{A} and oil P_{B} can, for example, be between 0.6 and 6, usually between 1.2 and 5, and in particular between 1.5 and 4.5.

In a further characteristic variation of the invention, the hydrocarbon feed of facility (I) comprises a refining residue R₀ typically provided by oil tanker and coming, for example, from refineries that are more than 1000 or even 1500 km away, for example refineries that have excess sulphur-containing fuel oil from the European Community.

Said residue R₀ typically comprises at least 30% by weight or 40% by weight or even 50% by weight of refinery vacuum residue, preferably a virgin vacuum residue, i.e., straight run vacuum residue. Said residue, which has not been cracked in a visbreaking unit or the like, is a better feed for at least partial transformation of oil in accordance with the invention. The transport of a refinery residue to a gas production zone to transform said residue into oil is a variation that can directly reduce excesses of sulphur-containing fuel oil.

Residue R₀ can also comprise aromatic cuts deriving from a fluidized bed catalytic cracking unit (usually termed FCC) from the refinery (typically boiling between 220° C. and 550° C., in particular between about 220° C. and 343° C. (LCO cut) or between about 340° C. and 550° C. (HCO cut).

The residue can also comprise a light diluent such as naptha or kerosene to reduce its viscosity and to enable it to be transported in a conventional oil tanker without the need for heating or to keep the temperature above 40° C. or even 30° C., preferably without substantial heating of the residue during transport, and more preferably without any heating.

Residue R₀ can comprise:
30% to 80% by weight, and usually 40% to 70% by weight of straight run vacuum residue from the refinery;
0 to 50% by weight and usually 10% to 40% by weight of aromatic catalytic cracking cuts (LCO/HCO);
0 to 30% by weight and usually 5% to 20% by weight of diluent typically composed of a refinery cut boiling below 340° C.

The catalytic steps: HDT, HDC, HDK, RHDT, RHDC (including the variations of mild hydrocracking, medium pressure hydrocracking and high pressure hydrocracking) can be carried out in one of the preferred variations of the invention with macroscopic supported solid catalysts, said term being applied, by the convention of the invention, to granular solids or extrudates with a characteristic dimension (diameter for beads or equivalent diameter (corresponding to the same cross section) for extrudates) in the range 0.4 to 5 mm, in particular between about 0.8 and 3 mm. Said catalysts comprise at least one metal or compound of a metal from group VIB (comprising molybdenum and tungsten) and at least one metal or compound of a metal from group VIII (comprising nickel). This variation thus excludes catalysts used in a slurry which typically have characteristic dimensions that are equal to or are approximately 100 micrometres, and which usually do not include an association of metals from said groups.

The residue treatment processes (RHDT, RHDC) can, however, be used both with macroscopic supported solid catalysts comprising at least one metal or a compound of a metal from group VIB and a metal or compound of a metal from group VIII than with catalysts used in a slurry. In accordance with one preferred variation of the invention, then, solid macroscopic type catalysts are exclusively used, comprising at least one metal or a compound of a metal from group VIB and at least one metal or compound of a metal from group VIII which typically have a better desulphurization activity than catalysts used in a slurry and which do not pose major problems with the amount of solid in the oils P_{A} and/or P_{B} produced in accordance with the invention. Further, they typically produce less gas. One characteristic of slurry processes is to carry out more severe conversion (up to more than 90% or 95% or even, 98% by weight of distillable compounds: vacuum distillate or lighter compounds). The ultimate residue is unstable, charged with carbon-containing solids.

In a further preferred variation of the invention, however, residue conversion is carried out at a very high conversion in the range [70% -98% by weight], preferably [80%-98% by weight] or in an ebullated bed followed by deasphalting, or preferably as a slurry, optionally followed by deasphalting, in particular to recycle the catalyst with asphalt. In these cases, the ultimate residue is unstable and burnt on site, for example in an incinerator/boiler producing pressurized steam.

Slurry conversion is thus important as it can minimize the ultimate residue by using a very high level of conversion.

The different variations of the invention will now be explained in more detail with reference to the accompanying drawings in which:

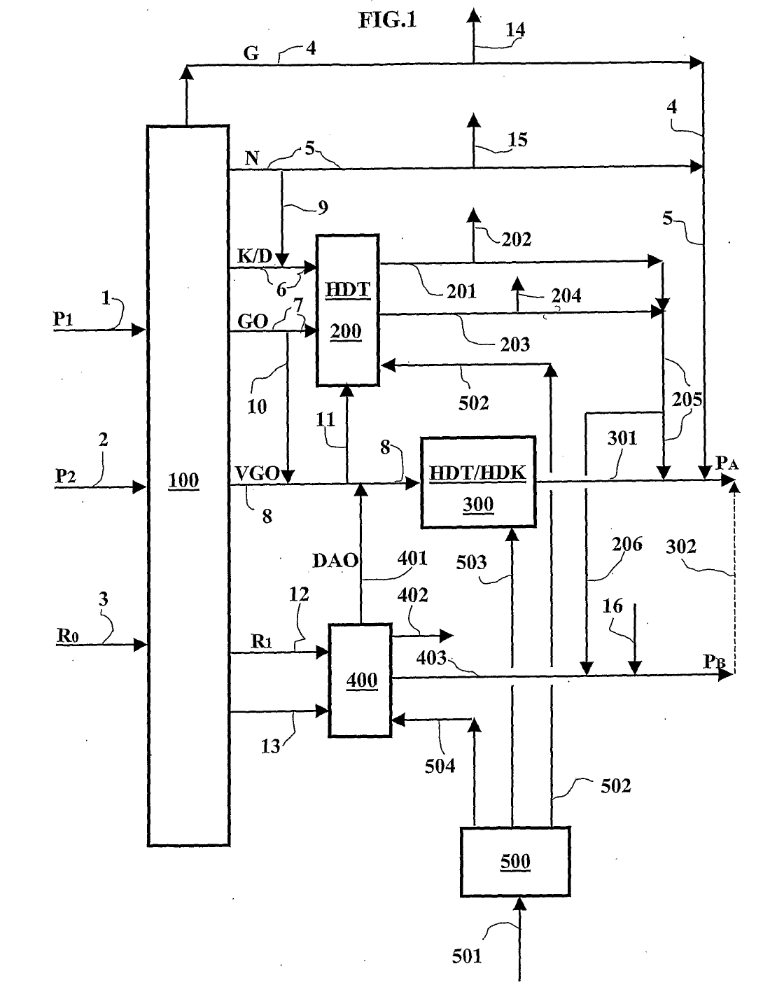

FIG. 1 represents an example of a facility for treating a hydrocarbon feed for use of a hydrocarbon feed using purified field gas in accordance with the invention. The facility is supplied with a feed C comprising three components: a crude oil P1 supplied via line 1, typically a conventional fluid transportable oil; a crude oil P2, optionally conventional fluid and transportable, or a heavier crude oil which is viscous and/or has a high pour point, and which is thus difficult or impossible to transport using an unheated pipeline; and finally, a refinery residue R₀ supplied via line 3.

These three components of the feed are treated separately or as a mixture in unit 100. This unit is typically distillation at substantially atmospheric pressure or more summary fractionation (simplified distillation with a restricted number of stages). In a variation, the feed C can be pre-cracked completely or partially (for example after eliminating light fractions) in unit 100. Said prior cracking can comprise:
a) thermal cracking under hydrogen (hydro-visbreaking); or
b) cracking in the presence of a hydrogen donating diluent, typically termed HDD and typically composed of a previously hydrogenated aromatic cut; or
c) hydroconversion in a slurry reactor.

The preferred variation for unit 100 is simple fractionation in two steps without pre-cracking:
distillation or simplified fractionation at substantially atmospheric pressure; then
vacuum distillation.

Typically, unit 100 produces: a gas comprising hydrocarbons containing 1 to 4 carbon atoms typically treated downstream to recover liquid fractions: propane and butane, evacuated via line 4; a naphtha (N) evacuated via line 5; a kerosene/diesel (K/D) evacuated via line 6; a gas oil cut, or atmospheric gas oil (GO) evacuated via line 7; a vacuum gas oil (VGO) evacuated via line 8; a vacuum residue R1 evacuated via line 12; an aromatic cut (LCO/HCO) derived from residue R0 evacuated via line 13.

The kerosene, diesel and atmospheric gas oil cuts (defined further in the description) are hydrotreated (HDT) in unit 200. The hydrotreated kerosene/diesel is evacuated via line 201; a fraction can be removed via line 202 to be sold as a refined product, for example engine gas oil.

The atmospheric gas oil fraction (GO) is evacuated after hydrotreatment via line 203; a portion of said hydrotreated gas oil can be removed via line 204 for sale as a domestic fuel or as heating oil. Other fractions can also be hydrotreated in unit 200 such as naphtha (N) supplied via lines 9 then 6, or vacuum gas oil (VGO) supplied via line 11. The (distillate) hydrotreatment unit 200 is also supplied with hydrogen via line 502, said hydrogen being produced from field gas (or purified field gas). In general, a hydrotreatment unit 200 can comprise communal or separate hydrotreatments for each of the treated cuts.

In FIG. 1, we show two outlet lines 201 and 203 corresponding to two separate hydrotreatments. It is also possible to hydrotreat kerosene separately to sell a fraction of said kerosene as a refined product or to hydrotreat all distillates as a mixture in a common hydrotreatment unit.

The vacuum gas oil (VGO) is evacuated from unit 100 via line 8 and at least partially supplies unit 300 for treating heavy distillates. This unit can also treat a fraction of atmospheric gas oil (GO) supplied via lines 10 then 8. It can also treat a deasphalted oil fraction (DAO) supplied via lines 401 then 8. Unit 300 can be a hydrotreatment unit (HDT) or, in a preferred variation of the invention, a hydrocracking unit (HDK) in one of the variations described above.

Highly advantageously, hydrotreatment (HDT) is carried out prior to hydrocracking. Unit 300 is supplied with hydrogen via line 503, said hydrogen typically being produced from field gas. The effluents from unit 300 are evacuated via line 301.

Typically, when carrying out hydrocracking at a sufficiently high pressure such as 8 MPa, or 10 MPa or, as is preferable, 12 MPa, or more preferably 15 MPa, the effluents from unit 300 comprise a diesel cut with a cetane index and cetane number of more than 52, usually more than 54, preferably more than 56, and more preferably more than 60.

Residue R1 evacuated from unit 100 via line 12 supplies residue treatment unit 400. typically, R1 is a vacuum residue or a residue comprising vacuum gas oil (VGO) or atmospheric residue. Unit 400 is also (optionally) supplied with an aromatic cut deriving from refinery residue R₀. This aromatic cut can typically comprise cuts deriving from a catalytic cracking unit (FCC) such as cuts boiling in the kerosene and diesel region, normally known as LCO, or atmospheric and vacuum FCC gas oil, known as HCO. This cut can also comprise a poor quality gas oil produced at the refinery, for example a cut boiling in the same distillation regions as LCO and/or HCO, deriving from a cokefaction unit. Residue treatment unit 400 can comprise residue hydrotreatment (RHDT) or residue hydroconversion (RHDC), typically high pressure, for example at a total pressure in the range 10 to 25 MPa.

RHDT hydrotreatment or catalytic hydroconversion of RHDC residues can be carried out with one or more reactors in a fixed, moving or ebullated bed or as a slurry. Other schemes for treating residue R1 are shown in FIGS. 2, 4 and 5. Unit 400 is also supplied with hydrogen produced from field gas supplied via line 504. Unit 400 typically produces an effluent stream moving in line 403. It can also produce a stream of deasphalted oil (DAO) moving in line 401 and a stream of coke or asphalt (in particular liquid) evacuated via line 402. However, preferred variations of the invention produce no coke or asphalt evacuated per se (not mixed with oil, or a fuel).

When using ebullated bed hydrotreatment, conversion to VGO and lighter products is usually limited to 30% to 70%, not exceeding the conversion level rendering the ultimate residue unstable. The operating conditions (in particular hydrogen pressure, temperature) and the catalyst can be selected so that the ultimate residue contains less than 1% by weight of sulphur. However, the capital cost can be minimized by operating at a high hourly space velocity (HSV) if the ultimate residue is to be desulphurized to only 2% by weight of sulphur.

The hydrotreated distillates moving in lines 201 and 203 are combined in line 205 then mixed at least in part with effluents from unit 300 moving in line 301 and supplemented with naphtha (N) supplied via line 5, and with a gas makeup, in particular butane and propane that can dissolve in the heavier liquid products supplied via lines 4 then 5. The overall mixture then forms a substantially asphaltenes free pre-refined oil P_{A}. The effluents from unit 400 moving in line 403 are typically supplemented with a stream of hydrotreated distillates moving in line 206 and a stream of heavy naphtha moving in line 16 (produced in unit 100, the outlet corresponding to the unit 100 not being shown in FIG. 1).

The treated residue diluted by said relatively light fractions then constitutes a residual oil P_{B} or reconstituted oil that is typically also pre-refined when it comprises hydrotreated compounds. Optionally, oil P_{A} and oil P_{B} can optionally be mixed using connecting line 302.

The facility shown in FIG. 1 also comprises lines 14 and 15 for evacuating gas and naphtha (N) for the sale of butane/propane and naphtha respectively.

FIG. 1 also shows a unit 500 for producing hydrogen from purified field gas supplied via line 501, the hydrogen produced moving in lines 502, 503, 504 to supply units 200, 300 and 400 respectively.

Unit 500 can comprise any known type of hydrogen production (for example steam reforming+steam conversion of CO+fractionation by PSA adsorption or any other mode of production comprising a partial oxidation step, for example, or using an autothermal process).

FIGS. 2 to 6 show variations of the facility or parts of the facility in accordance with the invention using the same numbering of lines or units as those shown in FIG. 1.

FIG. 2 shows a hydrocarbon treatment facility in accordance with the invention with a particular scheme for initial feed treatment unit 100. Unit 100a is an atmospheric type distillation fractionation unit operating, for example, at a column head pressure in the range 0.105 to 0.18 MPa, preferably with a limited number of separation stages, for example between 2 and 10 theoretical plates or even between 2 and 6 theoretical plates. It is possible to use major steam stripping, for example more than 40% by weight or 60% by weight or even 100% by weight with respect to the bottoms product, this stripping ratio and the temperature at the bottom of column 100a being selected to obtain at least one distillate with an end point (ASTM) of more than 380° C., for example in the range 390° C. to 470° C., in particular in the range 400° C. to 460° C. This distillate thus comprises light vacuum gas oil (LVGO) type fractions boiling between 371° C. and 460° C., which can be evacuated via line 6a, as a mixture with other fractions such as kerosene (K), diesel (D) and atmospheric gas oil (GO). The overall distillate is then hydrotreated, preferably as a mixture in unit 200. The product from the bottom of column 100a moves in line 12a and is subdivided into a fraction supplying a vacuum distillation column 100b and a fraction that does not undergo vacuum distillation, by-passing unit 100b via line 12b and being mixed with the bottoms product from unit 100b (vacuum residue). The resulting mixture R1, typically comprising the vacuum residue and a relatively heavy portion of vacuum gas oil, is then sent to unit 400. Typically for the facility of FIG. 2, unit 400 is a fixed, moving, ebullated bed or slurry hydroconversion unit, preferably a hydroconversion unit with fixed or ebullated bed(s). The relatively heavy vacuum gas oil separated from the head of column 100b is hydrodesulphurized then hydrocracked in unit 300, for example at medium pressure in the range 7 to 12 MPa, or at a higher pressure in the range 12 to 20 MPa, to obtain a conversion to products boiling below 371° C. in the range 42% to 94% by weight, in particular in the range 45% to 85% by weight, and as an example in the range 50% to 80% by weight with respect to the hydrocracked feed. In a variation, all of the product from the bottom of column 100a is sent to the vacuum distillation unit 100b. In a further variation, 10% to 90%, in particular 20% to 80% or 30% to 70% and as an example 40% to 60% by weight of the product from the bottom of the column 100a by-passes the vacuum distillation column 10b. Vacuum distillation is then supplied by the remainder, i.e. 10% to 90%, 20% to 80%, 30% to 70% or 40% to 60% by weight of the product from the bottom of the column 100a. The facility of FIG. 2 allows adjustment of the quantity of hydrocracked feed to be made to the quantity necessary for a particular aim, for example the overall quantity of diesel cut and/or desired minimum cetane index or number, in combination with the other parameters (conversion and hydrocracking pressure).

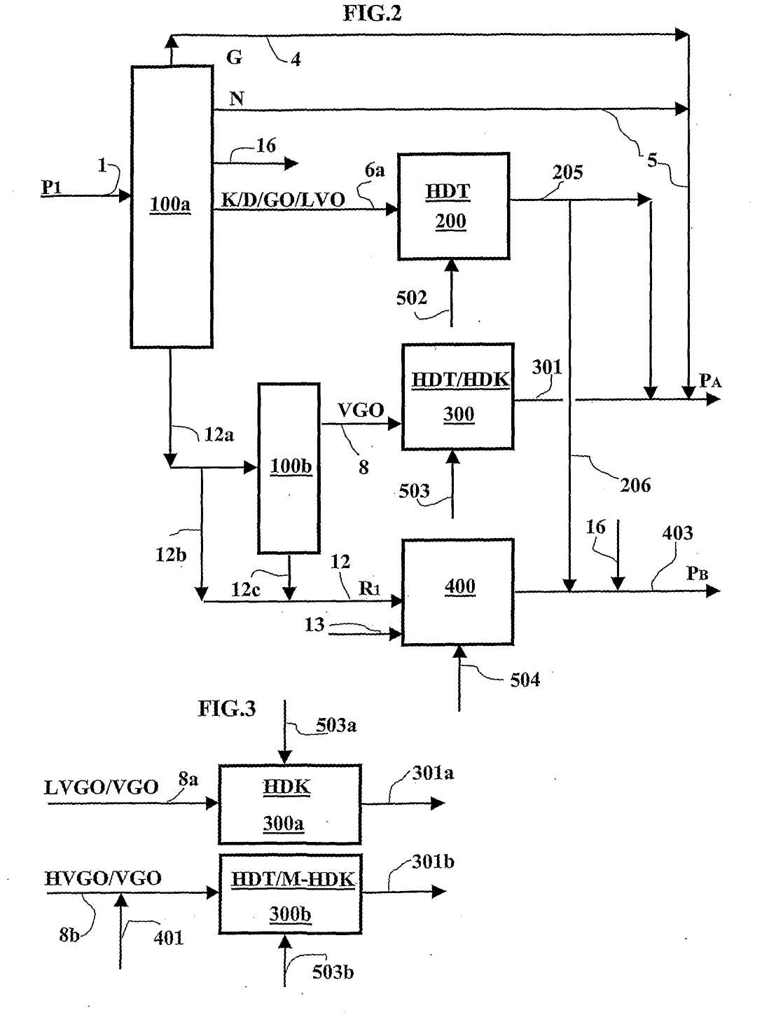

FIG. 3 shows an example of a vacuum gas oil treatment unit 300 comprising:
a hydrocracking unit 300a (typically after hydrotreatment) supplied via line 8a with a feed comprising a relatively light vacuum gas oil (LVGO) or a mixture (LVGO+VGO);
a hydrotreatment or mild hydrocracking unit 300b (conversion 20% to 42% by weight) for a feed supplied via line 8b, and comprising a relatively heavy vacuum gas oil (HVGO) or a mixture (HVGO+VGO), said feeds possibly being supplemented with deasphalted oil (DAO) supplied via line 31. The proportion of the overall feed from unit 300 which supplies unit 300a can vary between 20% and 80%, for example, or between 30% and 70% by weight. Units 300a and 300b can also be supplied with the same feed, for example VGO.

The units are supplied with hydrogen via lines 503a and 503b and their effluents move in lines 301a and 301b and are, for example, mixed downstream and form part of the composition of oil P_{A}.

That flowchart keeps for hydrocracking a relatively light feed that is easier to hydrocrack and allows moderate hydrotreatment and/or hydrocracking to be carried out, which is easier, on a relatively heavy feed (which can, for example, have an initial point (ASTM method) that is higher by 15° C. to 110° C. than that of the relatively light feed).

FIG. 4 shows a combination of a variation in unit 400 for treatment of a residue R1 comprising a solvent deasphalting unit 400a (propane, butane, pentane, hexane or a mixture thereof, or another solvent) with a unit 300c for converting the deasphalted oil produced (DAO). Preferably, unit 300c not only carries out hydrotreatment but also carries out hydroconversion of the DAO fed in a fixed bed or, as is preferable, in an ebullated bed. As an example, conversion of products boiling below 371° C. can, for example, be between 30% and 80% by weight, or between 40% and 70% by weight with respect to the DAO feed. Cracking can be hydrocracking (HDK) or mild hydrocracking (M-HDK) after hydrotreatment or hydroconversion (HDC), for example in an ebullated bed. Said hydroconversion can be carried out at medium pressure (for example between about 5 and 12 MPa). The hydroconverted effluent from unit 300c moves in lines 403a then 403 for mixing with asphalt evacuated from unit 400a via lines 403a, then 403. A fraction of the initial residue R1 (for example between 5% and 50% by weight) can also by-pass deasphalting via line 12d and be incorporated into the mixture. A fraction of the effluent from unit 300c (for example between 5% and 60% by weight) can also be evacuated via line 304, for example for incorporation into oil P_{A}. The substantial conversion of DAO results in a reduction in the proportion of uncracked oil in the final mixture and produces, as already stated, a concentration of asphaltenes in the final residue (typically oil P_{B}), in particular for residues with a moderated asphaltenes content.

As an example, it is possible to fractionate a light Arab crude (or any other conventional crude) by atmospheric distillation then vacuum distillation, carry out pentane deasphalting on the vacuum residue R1 to produce, compared with R1, typically about 80% by weight of DAO and 20% by weight of asphalt As in the case of light Arab. The DAO can then undergo HDC hydroconversion or a fairly severe hydrotreatment HDT in a hydrogen pressure that is in the range 7 to 14 MPa, for example, to render said DAO compatible with its subsequent supply to the fluid catalytic cracking (in a refinery other than the facility of the invention). Preferably, said DAO undergoes mild hydrocracking (M-HDK) at a hydrogen pressure that is similar but with a catalyst producing moderate cracking to obtain 30% to 40% by weight conversion, principally to gas oil GO and kerosene K cuts. All or part of the effluent from hydroconversion or hydrotreatment or mild hydrocracking of the DAO can then be mixed with asphalt As (preferably kept hot in the liquid form) and other distillable fractions: naphtha, kerosene, gas oil, vacuum distillate, derived from fractionating the initial crude, said fractions preferably being hydrotreated in advance, in particular for kerosene type K or heavier fractions, to obtain a reconstituted oil P_{B} with high fluidity, which can be transported through unheated pipelines (as is the case with oil P_{A}).

It may also be desirable to dilute asphalt As not to reconstitute an oil P_{B,} but a fuel, in particular HTS (high sulphur fuel, typically less than 3%, 3.5% or 4% by weight of sulphur depending on national standards). Part or all of said HTS fuel can advantageously be used locally as bunker fuel for oil tankers. In this case, it is possible to mix the asphalt As with a reduced quantity of diluent, preferably desulphurized. It is possible to use a portion of the hydrotreated DAO or, as is preferable, mild hydrocracking effluent (M-HDK) from DAO, in particular the lightest fractions produced (GO, LVGO, VGO). It is also possible to use a portion or a light fraction of a hydrotreatment or mild hydrocracking effluent of VGO or a VGO-DAO mixture in any proportions. The proportion of diluent with respect to the asphalt As is generally in the range 25% to 150% by weight, and selected as a function of two criteria: the need for a suitable viscosity for the fuel (and thus of a sufficient quantity of a sufficiently fluid diluent) and the desired sulphur content for the fuel. The fuel can also be obtained by diluting the asphalt with a small quantity of topped crude. Finally, the fuel may have undergone visbreaking or hydrovisbreaking to reduce its viscosity.

In this variation of the invention with the production of fuel, a white oil P_{A} which is typically minimally desulphurized and a small quantity (for example 5% to 15% by weight) of fuel with a sulphur content that is typically less than that of the vacuum residue of the starting crude are produced. The VGO fractions of the initial crude can typically be treated by HDT, M-HDK, or medium or high pressure hydrocracking before generally being incorporated into the white oil P_{A} with at least a portion of the DAO after HDT or M-HDK of the K and GO fractions, usually hydrotreated, and naphtha fractions which may or may not have been desulphurized, all said fractions deriving from the starting crude. The sulphur content of the white oil Pa may be less than 500 ppm by weight, or even less than 150 ppm, or even 10 ppm.

Clearly, all of the technical features described above can be used to produce not a fuel but an oil P_{B}. Similarly, the production of (oil P_{A}+oil P_{B}) or [oil P_{A}+fuel] do not prevent the production of a certain quantity of refined products, in particular naphtha, gasoline, kerosene and/or gas oil. In particular, certain of said products: kerosene and gas oil: can be obtained from HDT of GO and/or HDK or MP-HDK of VGO and/or DAO. Gasoline can be obtained from reforming or hydroisomerization of naphtha. In the case of reforming, this can produce at least a portion of the hydrogen used for the H₂ units (HDT, HDK, etc . . . ).

FIG. 5 shows a residue treatment unit also comprising a deasphalting unit 400a, and furthermore a unit 400b for residue hydrotreatment (RHDT) or for residue hydroconversion (RHDC). A fraction of residue R1 (for example in the range 25 to 75% by weight or in the range 30% to 70% by weight) supplies the unit 400b via line 12e, the effluent being evacuated via line 403b. The fraction of the residue R1 supplying deasphalting unit 400a is typically in the range 25% to 75% by weight, or in the range 30% to 70% by weight. A complementary fraction, typically in the range 0 to 50% by weight, can optionally by-pass units 400a and 400b. This fraction may also be zero, with all of residue R1 being treated. A stream of diluent (for example all or a portion of the DAO after hydroconversion as described in FIG. 4) can be incorporated into the global effluent (from 403a, 403b, and optionally an untreated portion of R1) via line 303. This treatment scheme is suitable for residues with a considerable percentage of asphaltenes (for example more than 10% by weight) as indicated above. In a variation, all of residue R1 supplies section 400b; there is then no more deasphalting.

Typically, in a facility (I) in accordance with the invention, the effluents from each of units 200, 300, 400 can be evacuated without fractionation or with partial fractionation. As an example, the hydrocracking effluents (unit 300, in particular of the M-HDK, MP-HDK or HDK type, preferably single pass, usually with moderate conversion between 30% and 60% by weight) can be evacuated without fractionation of the hydrocracking effluent (or fractionation of only a portion of the unconverted vacuum gas oil, to recycle it). It is possible just to carry out stripping of the H₂S produced. For unit 400, and the constitution of the oil P_{B,} it is also preferable not to separate or only to partially separate, usually without recycling the fractions. If hydroconversion is carried out, then preferably the quantity of light naphtha at the outlet is limited to improve the stability of the hydroconverted residues. The light naphtha/heavy naphtha ratio for the oil P_{B} can optionally be less than 0.3 or even 0.2 or even 0.15.

In general, whatever the treatment carried out in accordance with the invention, maximum thermal integration is preferably sought to avoid as far as possible any cooling then intermediate heating of the products, and intermediate product storage between the various units. As an example, if a facility of the type shown in FIG. 1 is used, comprising a unit 100 for initial distillation then vacuum distillation, a unit 200 for hydrotreatment of middle distillates, a unit 300 for hydrotreatment HDT or hydrocracking (M-HDK, MP-HDK or HDK), a unit 400 for hydroconversion of residues, for example in an ebullated bed or in a slurry, then any intermediate cooling is preferably avoided along with storage between unit 100 and units 200, 300 and 400. However, limited cooling of the cuts produced by the distillation columns of unit 100 can optionally be carried out so that the pumps transferring said cuts to units 200, 300, 400, typically under a high pressure of hydrogen and high total pressure, operate at a temperature that is not excessive, for example between 150° C. and 350° C.

Thermal integration can optionally result in the employment of an exchange string to reheat the starting crude at the inlet to unit 100 upstream of the atmospheric distillation column or any desalter, said exchange string providing heat exchange with all or part of the effluents from units 200, 300 and 400. This uses a feed/effluent exchange string that is not mainly in the fractionation unit 100 but in the facility for treatment of the entire crude. This type of integrated thermal facility can also be employed with any type of facility of the invention and is rendered possible by the fact that said facilities are much less complex than a complete refinery and thus allows deeper integration. As an example, it is also applicable to variations of the facility with deasphalting, the inlet crude can also exchange heat with all or a portion of the effluents from any units for HDT of GO, K, VGO, DAO (separately or as a mixture) and/or any units for HDK, M-HDK, MP-HDK of VGO and/or DAO (separately or as a mixture) and/or any residue RHDC units. Intermediate storage (for example only hot liquid asphalt) is also desirably limited or avoided. Similarly, vacuum distillation is preferably carried out with neither cooling nor storage at atmospheric pressure, typically effecting simplified summary fractionation.

It is also possible to use facilities with a simplified design using parts that are common to several units. In particular, operating pressures that are identical or similar can be selected for at least part or all of the units under hydrogen pressure such as HDT, HDK, M-HDK, MP-HDK, HDC or RHDC for GO, K, VGO, DAO or residue feeds (separately or as a mixture), to be able to use a common hydrogen circuit for a plurality of units (2 or more), whether the hydrogen supplies the units in parallel or in series. This means that a common compressor can be used for those units as well as a common system for treating the purge gas and/or amine washing gas. As an example, it is possible to use an HDT or M-HDK DAO unit with a hydrogen circuit that is common with a VGO MP-HDK unit. It is possible to use a circuit supplying said units in parallel, the supply pressure of the compressor being about 10 MPa, for example. It is also possible to use hydrogen in series in the two units, the pressures in the corresponding reaction zones differing by about 1 to 3 MPa.

Similarly, it is possible to use a common hydrogen circuit, in parallel or in series, for units for HDK, for example for VGO, and hydroconversion of the RHDT residue, for example in an ebullated bed or slurry, with pressures in the range about 13 to 18 MPa.

A further simplification may result from treatment of a mixture, for example HDT of KIGONVGO as a mixture.

FIG. 6 shows an example of a stream of feeds and products around a facility (I) for using purified field gas in accordance with the invention. Said facility is supplied by a feed with three components:
a conventional fluid oil P1 which is highly transportable, typically supplied by oil tanker from a distant zone that may be more than 2000 km away (for example imported from a country with a coast in the Persian Gulf);
an oil P2 produced close to the facility (I), optionally a heavy oil, which is viscous and difficult to transport;
a refinery residue R₀ deriving, for example, from an oil refinery REF3 in the USA or typically from a European Community member state.

Facility (I) can produce refined oil products PR1, . . . , PRn (generally in relatively limited quantities) for a local or regional market. It also produces, in accordance with the invention, at least one pre-refined oil, such as oil P_{A}, pre-refined oil, non residual, of high quality and high upgradability, which can be exported to an oil refinery REF1, for example a refinery in the USA or, typically, a European Community member state. Typically, said oil is destined for a refinery which needs to reduce its heavy fuel oil production. The facility of FIG. 6 also produces a residual oil P_{B} the vacuum residue of which comprises asphaltenes and which typically has a sulphur content that is lower than that of the residue in the starting feed, generally less than 2% by weight, preferably less than 1% by weight and highly preferably less than 0.8% by weight. This sulphur content of the vacuum residue of P_{B} is typically more than 0.52% by weight and is, for example, in the range 0.52% to 0.75% by weight. Said oil can be exported and can be satisfactorily upgraded in many refineries, for example a refinery in the USA or in a European Community member state or in a South American state. Typically, said oil is destined for a refinery that has an outlet for the heavy fuel oil resulting from refining it.

Advantageously, oils P_{A} and P_{B} have compositions suited to maximum upgrading. As an example, oil P_{A}, if exported to the European Community, may have a high hydrocracked diesel cut content (with a very high cetane index and number, for example 54 or more), while residual oil P_{B,} particularly if exported to the USA, can have a lower cetane index or number. Its kerosene content, in contrast, will advantageously be higher than that of oil P_{A}.

The facility (I) of FIG. 6 is advantageously situated on a site where gas is abundant and cheap, typically close to large gas fields.

Optionally, the facility (I) can be installed on the principal oil transport routes which leads to importing oil from a content, to pre-refine said oil close to or at destination for one of the large global consumption zones, and to re-export the pre-refined oil to the major global consumption zones located in other continents.

The invention can also be implemented by installing the hydrocarbon treatment facility in the country or region producing processed crude oil. A facility in a country producing Arab-Persian Gulf oil could readily export residual oil (P_{B}) to the Far East where openings for heavy fuel are relatively numerous, and pre-refined oil P_{A} to Europe, the USA or Japan.

If a refinery residue is also treated, it is possible to use an oil tanker with a dual purpose:
conventional use of said oil tanker to transport crude oil from an oil producing state A to an oil consuming state B;
use of the same oil tanker, typically on its return trip, to transport a refinery residue (typically comprising a residue from one or more refineries in state B) to state A or a state C close to A. Facility (I) of the invention it then typically installed in state A or C, preferably close to a delivery port for the transported residue.

The invention also provides a process for pre-refining a crude oil P1 to use gas in any one of the variations described above, and in particular a process comprising:
a step for initial fractionation of an oil P1 to produce a fraction F that is substantially free of asphaltenes and mainly comprises compounds with a boiling point of more than 371° C.;
a step for hydrocracking at least the major portion of said fraction F at a total pressure of at least 7 MPa, preferably in the range 8 to 18 MPa, in particular in the range 9 to 15 MPa;
optionally, but preferably, incomplete fractionation of hydrocracked effluents (i.e. fractionation that does not eliminate from the effluents all of the unconverted gas oil included in the effluents), for example not eliminating at least 30% by weight, or at least 40% by weight and typically at least 50% by weight and usually 100% by weight of unconverted vacuum gas oil or the fraction boiling at a temperature of 371° C. or more;
optionally, adding to the hydrocracking effluents at least one oil fraction P1 that is free of asphaltenes, in particular a fraction of hydrotreated middle distillates; to form an oil P_{A} that is substantially free of asphaltenes comprising a diesel cut with a cetane index of 50 or more.

The invention also concerns any pre-refined oil that is substantially free of asphaltenes (P_{A}) and/or any residual oil (P_{B}) produced by a facility (I) of the invention, or by the process of the invention or using gas in accordance with any one of the variations of the invention described above.

The invention also concerns any oil fraction or refined product comprising at least one fraction derived from an oil (P_{A}) or (P_{B}) produced by a facility (I) of the invention, or by the process of the invention or using gas in accordance with any one of the variations of the invention described above.

The invention also concerns an oil produced by the facility (I) and/or a pre-refined oil P_{A}, also produced by (I) and/or a feed for supplying to an oil refinery and/or a feed to supply a unit for distillation of oil in an oil refinery, said feed having the following characteristics: (in the following and to the end of the paragraph, the feed is any of the feeds cited above and also an oil or a refined oil (P_{A}) produced by a facility (I) of the invention, as cited above):
API density in the range 40 to 64, or in the range 41 to 60, or in the range 42 to 54.

Typically, the flash point of the feed is less than 58, or even less than 56, or 54, or 52 or 50 or 47 or 43 or 40, or lower, for example less than 37 or less than 34, or 31, or possibly less than 28° C. Obtaining a low flash point is easy by leaving out or incorporating light fractions such as naphtha into the feed in sufficient quantities.

The initial point (ASTM) of the feed is typically less than 150° C., in particular less than 130° C. or less than 110° C. or 90° C. or 70° C. and may be less than 60° C. or even 50° C. The end point (ASTM) of the feed is usually higher than 350° C., generally more than 362° C., for example more than 373° C. in particular 385° C. and typically more than 395° C. or 405° C. and even more than 420° C.

The 10% distilled point (ASTM) of the feed can, for example, be between 50° C. and 110° C., or between 30° C. and 90° C. or between 70° C. and 170° C. The 90% distilled point (ASTM) can, for example, be more than 305° C., in particular more than 315° C. or more than 325° C. or even in the range 340° C. and 550° C. or between 300° C. and 500° C. or between 373° C. and 580° C. The percentage distilled at 285° C. can, for example, be less than 76% or 70%.

Obtaining a lower or higher initial and end point is easy for the skilled person by incorporating larger or smaller quantities of light naphtha and/or heavy naphtha and for the end point, modifying the quantity of vacuum gas oil left in P_{A}. The quantities of naphtha can be increased if necessary by carrying out more severe vacuum gas oil hydrocracking. Excess fractions can be incorporated into a finther oil P_{B} produced by the invention. Similarly, the skilled person knows how to adapt the distilled percentages by incorporating or eliminating cuts as appropriate.

Said feed can also comprise a diesel fraction with a cetane index in the range 45 to 70 or between 52 and 70 or between 53 and 70 or between 54 and 70. Said feed can also comprise a diesel fraction with a cetane number in the range 47 to 73, or between 49 and 73 or between 50 and 73 or between 51 and 73 or between 52 and 73 or between 53 and 73 or between 54 and 73 or between 55 and 73. It can also comprise a diesel fraction with an aromatics content, as a % by weight or a % by weight of aromatic carbon, in the range 2% to 35%, or between 2% and 25% or between 2% and 15% or between 2% and 12% or between 2% and 8% by weight. The sulphur content of said diesel fraction can be in the range 2 ppm by weight to 1% by weight, or between 2 ppm and 0.5% by weight or between 2 ppm and 0.3% by weight or between 2 ppm and 0.1% by weight or between 2 ppm and 500 ppm or between 2 and 300 ppm or between 2 and 200 ppm or between 2 and 150 ppm or between 2 and 100 ppm or between 2 and 70 ppm or between 2 and 40 ppm or between 2 and 25 ppm or between 2 and 15 ppm or between 2 and 10 ppm.

Said feed can also comprise a fraction boiling above 343° C. or 371° C., one or other of said fractions may have a density of less than 0.900 or less than 0.890 or less than 0.880 or less than 0.870 or less than 0.865 or less than 0.86, and generally more than 0.840. The aromatics content as a % by weight or the % by weight of aromatic carbon of one or other of said fractions can be in the range 2% to 25% or between 2% and 20% or between 2% and 15% or between 2% and 12% or between 2% and 8% by weight. The sulphur content of one or other of said fractions can be in the range 2 ppm by weight to 1% by weight or between 2 ppm and 0.5% by weight or between 2 ppm and 0.3% by weight or between 2 ppm and 0.1% by weight or between 2 ppm and 500 ppm or between 2 and 300 ppm or between 2 and 200 ppm or between 2 and 150 ppm or between 2 and 100 ppm or between 2 and 70 ppm or between 2 and 40 ppm or between 2 and 25 ppm or between 2 and 15 ppm or between 2 and 10 ppm.

The amount of (nickel+vanadium) in the feed can, for example, be less than 50 ppm by weight or less than 30 ppm, 20 ppm or 10 ppm, or typically less than 5 ppm, in particular less than 3 ppm and usually less than 2 ppm and even less than 1 ppm by weight.

The (nickel+vanadium) content of the fraction of the feed boiling above 565° C. can, for example, be less than 20 ppm by weight or less than 10 ppm or typically less than 5 ppm, in particular less than 3 ppm and usually less than 2 ppm and even less than 1 ppm by weight.

Said properties, which can be employed together when they do not contradict each other, can be obtained by treating an oil such as Arabian light, which is conventional and fluid and has a low pour point as defined in the invention by separate hydrotreatment of naphtha, kerosene mixed with the diesel and gas oil cut and by carrying out high pressure hydrocracking of the vacuum gas oil. The residue can be treated by hydrotreatment and incorporated into the oil P_{B}. It is possible to obtain:
diesel cuts with a high cetane index or number by carrying out severe hydrotreatment of the straight run cut (low HSV, high pressure) and/or by carrying out hydrocracking at a higher pressure and conversion of the vacuum gas oil. Intensifying those operations also reduces the sulphur content. The skilled person will readily be able to modify the various parameters by adjusting the following factors:
the possibility of eliminating certain cuts in the form of refined products or incorporated into a further oil P_{B};
intensifying or modifying the hydrotreatment and/or hydrocracking operations;
the percentage of feed supplied to those operations;
by-passing an untreated portion of the feed. This simulates a certain amount of pollution during transfer of an oil produced by traces of other less pure products.

The various elements described in the present description: variations, oil selection, choice of parameters and properties of products, etc, can optionally be combined together and employed in accordance with the invention; any combination of said elements thus forms part of the present invention.

### Definitions and conventions used in the invention/properties:

The term field gas means any hydrocarbon gas from one or more fields, production being carried out underground and/or offshore. Field gas includes gas from natural gas fields, gas associated with oil, gas with “condensates” (comprising, in addition to gaseous hydrocarbons, light liquid hydrocarbons and traces of heavier hydrocarbons) and mixtures thereof, and in general any gas from subterranean fields and/or offshore fields comprising considerable quantities of methane. Said gas typically also comprises hydrocarbons containing 2, 3 or 4 carbon atoms, in general small quantities of higher hydrocarbons containing 5 to 20 carbon atoms, or more. They usually include non hydrocarbon compounds such as N₂, CO₂, H₂S and sometimes rare gases. The use of field gas for the production of hydrogen thus, in the majority of cases, demands prior purification of the gas to eliminate undesirable compounds. Gas purification can, for example, comprise steps for amine washing, dehydration or degasolining. Field gas is abundant in many regions of the world, in particular in regions far away from the major gas consumption zones such as Europe, the USA excluding Alaska, and Japan. The term “gas production region” means the region around one or more gas fields used in accordance with the invention after purification, such as any point located at most 1200 km from a field or a group of fields from which at least 70% by weight of the purified gas used in the invention derives. Typically, at least 90% by weight and usually all of the gas is produced less than 800 km from the facility (I), generally less than 500 km away and even less then 300 km, and typically less than 200 km. regarding the terms “crude oil production region” or “field nearby” the underground “nearby” gas and/or oil, reservoir or aquifer (for H₂S and/or CO₂ sequestration), the same definitions are used: less than 800 km from the facility (I), generally less than 500 km away and even less then 300 km, and typically less than 200 km.
A pre-refined oil P_{A} or a residual oil P_{B} produced using one of the variations of the invention is a complex mixture of hydrocarbons from a hydrocarbon treatment facility (I) in accordance with the invention, said mixture characteristically being intended for treatment in one or more oil refinery(ies), supplied to at least one initial oil distillation unit (usually termed atmospheric distillation). In accordance with the invention, the pre-refined oil P_{A} comprises compounds that have been hydrotreated and/or hydroconverted and/or hydrocracked using any one of the variations of the invention for the hydrocarbon treatment facility of the invention. Oil P_{B} (residual oil, as it comprises vacuum residue containing asphaltenes) can optionally be an oil that is free of said compounds, for example a reconstituted oil comprising a residue with an enhanced asphaltenes content. Generally, P_{B} is also a pre-refined oil as defined above. In accordance with the invention, an oil P_{A} or P_{B} produced in accordance with the invention is a “final product from the hydrocarbon treatment facility (I)” and not an intermediate product moving in an oil refinery, for example. It is intended for refining in one or more oil refineries that are distinct and distant, conventionally, at least 100 km from the hydrocarbon treatment facility (I) Usually, at least part of the oil produced, (P_{A} and/or P_{B}) is intended to be refined at very large distances such as 2000 km or 10000 km or more, in particular on another continent, and transported by oil tanker, in particular by a very high tonnage oil tanker such as at least 150 000 tonnes deadweight, typically in the oil or crude oil transporter tanker category, as defined by a classification company such as the Véritas Bureau in France or the American Bureau of Shipping. An oil (Pa and/or P_{B}) produced in accordance with the invention is also a product prepared for regular production and commercialization and not a product such as a product that is transferred only occasionally, for example a refined product that is temporarily outside specifications, or temporary product during stoppages of certain units in an oil refinery. It is thus typically a normal feed for supplying to an initial oil distillation stage in an oil refinery, this type of feed typically being treated in campaigns. Typically, it is not classified as a refined oil product in the sense of conventional refined oil products from the group formed by (liquefied petroleum gas, gasoline, solvents, aircraft fuel such as kerosene, lamp oil, engine gas oils, domestic fuel possibly termed heating oil, shipping fuel oil, light fuel oil, heavy fuel oil, lubricating oil, bitumen and cutback), and this is typically in accordance with the classification of a refinery refining said oil and/or in accordance with the administrative classification of the state in which (I) is situated and/or that of a state in which the oil is discharged for refining and/or the customs classification of the state in which (I) is located and/or that of the state in which said oil is discharged for refining. In contrast, an oil of the invention is typically classified in accordance with at least one or more facilities or each of those authorities as an oil or crude oil or synthetic oil or a pre-refined oil and possibly as “syncrude”, this type of classification clarifying its destination. An oil produced in accordance with the invention generally comprises at least five cuts, usually six cuts or even five cuts from the group formed by: light naphtha, heavy naphtha, kerosene, gas oil, diesel, vacuum gas oil, vacuum residues in which, conventionally, in accordance with the invention, we designate cuts or fractions of a hydrocarbon feed or of an oil by their true boiling point (TBP) with the lower limit included and the upper limit excluded, and in which “Light naphtha” designates the cut between 28° C. and 71° C., “heavy naphtha” designates the cut between 71° C. and 160° C., “kerosene” designates the cut between 165° C. and 282° C., “diesel” designates the cut between 282° C. and 343° C., “gas oil” designates the cut between 343° C. and 371° C., “vacuum gas oil” designates the cut between 371° C. and 565° C., and “vacuum residue” designates the cut boiling at a temperature of 565° C. or more. Typically, an oil of the invention comprises at least 1.5% and usually at least 3% of its total weight in at least 3, 4 or 5 of said cuts. Usually, an oil P_{A} can have 2% to 15% by weight of light naphtha (or 3% to 12%), 5% to 20% of heavy naphtha (or 6% to 17%), 6% to 24% of kerosene (or 8% to 21%), 4% to 20% of diesel cut (or 6% to 17%), 1.5% to 10% of gas oil and 2% to 28% of vacuum gasoline and residue substantially free of asphaltenes. This definition of the cuts or fractions is applicable to calculating the properties of fractions of a complex mixture such as the sulphur content, cetane index, asphaltenes content, etc . . . The cuts described in the description of the variations and Figures are much narrower fractionation cuts and can, for example, be defined by ASTM values with initial and end points and may have a rather coarser fractionation.
In accordance with the invention, a conventional fluid oil is an oil having:
   an API density of at least 25;
   a viscosity at 2° C. of less than 230 cSt (centistokes) and at 15° C. of less than 80 cSt;
   a pour point of less than 0° C.
   This definition is restrictive. It is possible to pump products with a viscosity of 1000 cSt or more.
   This definition is, for example, more restrictive than the conditions mentioned in the reference text “Upgrading petroleum residues and heavy oils” by Murray R Gray, published by Marcel Dekker Inc. New York, page 37 lines 6 to 13, which mentions one condition for being able to transport by pipeline and sell products on the open market which is as follows: a viscosity of about 250 cSt at 2-3° C. or less or of about 100 cSt at 15° C.
   Typically, the viscosity of a conventional fluid crude of the invention at other temperatures are: less than 35 cSt at 38° C., and less than 20 cSt at 99° C. Generally, the conventional fluid oil chosen will have still lower viscosities, namely: less than (150 cSt, 65 cSt, 50 cSt, 32 cSt, 15 cSt) respectively at (2° C., 15° C., 21° C., 38° C., 99° C.) or even less than (120 cSt, 50 cSt, 35 cSt, 20 cSt, 10 cSt) for the same temperatures.
   According to a generally accepted definition indicated as a recognized classification in the reference text cited above (“Upgrading . . . ”, page 2), heavy crudes have an API density in the range 10 to 20. They also have a viscosity that is substantially higher than the values cited above rendering transport very difficult or even impossible without a diluent.
   Typically, the conventional fluid oils selected comprise at least 20% by weight, usually at least 24% by weight or even 26% by weight of compounds with a boiling point of less than 325° C. Their vacuum residue typically represents less than 36% by weight, usually less than 34% by weight and in particular less than 32% by weight with respect to the whole conventional oil.
   In accordance with the invention, when a conventional fluid oil is selected, then typically an oil is selected the characteristics of which (viscosity and pour point) allow it to be transported readily within its production region, in particular in conventional unheated pipelines. Thus, the conventional fluid oil can be routed via conventional means without using the known process for transportation of heavy oils: the use of dilution/separation of the diluent at the outlet from the pipeline/recycling the diluent, which can therefore be avoided.
   A conventional fluid oil of the invention is thus selected as a function of the site of the treatment facility in order to be readily transportable. Generally, the conventional fluid oil is produced from an offshore field or terrestrial field, and transmitted to the treatment facility (I) which is typically located on a terrestrial site, usually a few km away, usually several tens of km away, and sometimes several hundred km away. In a preferred variation of the invention, the choice of a transportable oil is thus important in order to limit plant costs.

Conventionally, in accordance with the invention, a treatment with carbon discharge is a treatment comprising:
either a cokefaction step for the residue in a fluidized bed or in a chamber, producing solid coke;
or a process comprising pyrolysis of the residue on a non organic solid at a temperature of more than 500° C. forming coke on said solid, said coke typically being burnt.

In accordance with the invention, it is possible to use carbon discharge, for example less than 10% by weight of the feed for (I). However, typically, substantially no carbon discharge is used, i.e. conventionally, less than 2% by weight of the feed, and preferably no carbon discharge.

Conventionally, in accordance with the invention, the liquid yield of the treatment carried out is the ratio of the mass of compounds in the hydrocarbon feed containing at least 3 carbon atoms to the mass of compounds comprised in the liquid hydrocarbons produced by facility (I), also containing at least 3 carbon atoms. This ratio is calculated by excluding the sulphur content of the feed and the products of the facility.

In a preferred variation of the invention, by excluding gasification and the combustion of asphalt and asphalt evacuation, and all coke-forming processes, the liquid yields can reach at least 96% by weight, or at least 97% by weight or at least 98% by weight or at least 99% by weight, or even at least 100%, if more hydrogen is incorporated than is lost of light compounds (methane+ethane). The use of macroscopic supported catalysts such as those described above (rather than liquid catalytic additives or slurry) can typically for residue hydrocracking and hydroconversion, limit the production of gas (methane, ethane) to less than 0.8% by weight for each step, and even less than 0.6% by weight. Preferably, conversion of the products boiling above 565° C. is also limited (for example to less than 70% by weight or less than 65% by weight or less than 60% by weight). The conversion is typically selected so that the unconverted residue (boiling above 565° C.) is stable in the oil produced, for example P_{B}. It is possible to use a stability test such as the SHELL hot filtration test or a further test for the stability of fuels or residues.

The liquids produced by a facility (I) of the invention comprise one or more oils P_{A}, P_{B} but also possibly refined products such as naphtha, or fuel oil or kerosene. Typically, the refined products can cumulatively represent between 0 and 92% by weight with respect to the total weight of liquid products from facility (I), in particular between 0 and 85% by weight, generally between 0 and 75% by weight, or between 0 and 60% by weight, for example between 0 and 50% by weight, usually between 0 and 30% by weight, preferably between 0 and 20% by weight, and highly preferably less than 10% and in particular 0% (no refined products).

The pre-refined oil P_{A} and the residual oil P_{B} can be sent to one or more oil refineries, generally alone or mixed with other natural or synthetic oils.

### EXAMPLES

A crude oil P1 with the following characteristics was selected and supplied via pipeline:

Characteristics of oil P1:

| | |
|---|---|
| API density: | 33.4 |
| sulphur content: | 1.77% by weight |
| viscosity at 15° C.: | 13 cS |
| viscosity at 2° C.: | <100 cS |
| pour point: | <−10° C. |

Characteristics of vacuum residue:

| | |
|---|---|
| sulphur content: | 4.2% by weight |
| asphaltenes content: | 5.2% by weight |
| % by weight on crude: | 18% |

A field gas produced from a gas field located 30 km from the pre-refining facility I was treated by pre-refining, dehydration, degasolining and extracting butane and propane to obtain a purified gas comprising principally methane, about 10% by weight of ethane and small quantities of propane (less than 1% by weight).

Said purified field gas was converted by steam reforming then by steam conversion of carbon monoxide, and final purification by PSA adsorption (pressure swing adsorption). After eliminating the residual water by condensation, the dry gas underwent CO₂ absorption with a MEA (monoethanolamine) solution. The desorbed CO₂ was compressed to a pressure of 10 MPa. The recovered hydrogen G1 was also compressed and sent to a pre-refining unit to supply the units with hydrogen. A further flow of gas G2 was used as a fuel gas.

### Example 1

A crude P1 was fractionated by summary atmospheric distillation at 0.2 MPa (atmospheric primary distillation) and at 0.015 MPa (vacuum distillation) into three cuts defined by their ASTM initial and end points (which differ from the conventional definitions as fractionation was summary):
a naphtha cut N with an end point of 190° C.;
a middle distillate cut D-M with an initial point of 150° C. and an end point of 371° C.;
a vacuum distillate V-G-O with an initial point of 340° C. and an end point of 565° C.;
a vacuum residue V-R with an initial point of 540° C.

D-M underwent HDT hydrotreatment at a pressure of 6 MPa and the V-R residue underwent pentane deasphalting to produce a deasphalted oil fraction D-A-O and an asphalt stream A-S.

V-G-O and D-A-O were hydroconverted (desulphurizing treatment step) as a mixture in an ebullated bed catalytic hydroconversion HDC step at a pressure of 7.5 MPa to obtain a conversion of 70% by weight of the D-A-O into fractions boiling below 565° C.

The asphalt was mixed with a supplemental quantity of untreated crude oil of the same quality as P1 representing 38% by weight with respect to P1, to produce the residual oil P_{B}.

The hydroconversion effluent HDC, hydrotreated middle distillates D-M and untreated naphtha N were mixed to form an oil P_{A} which was free of asphaltenes, comprising a vacuum residue with a sulphur content of less than 0.1% by weight.

P_{A} and P_{B} are each conventional oils suitable for refining in a conventional refinery. Each of them comprise more than five cuts (with conventional definition) in a quantity of more than 3% by weight. These oils are very different since P_{A} is asphaltenes free, has a high kerosene and diesel content and has a very low sulfur level, far less 0.4% by weight. On the contrary, P_{B} has a higher sulphur content than P1, and a far lower kerosene and diesel content than P_{A}.

As a preferred variation, D-M can be hydrotreated (HDT) by hydrotreatment at a higher pressure of 8 to 10 MPa and lower spatial velocity, and V-G-O and D-A-O are hydrotreated, then hydrocracked under a high hydrogen pressure of 16 MPa with a conversion of VGO+DAO into middle distillates of 60% by weight. Conversion can be adjusted by conventionnal way (adaptation of temperature and/or spatial velocity VVH). Within such variation, the cetane index of P_{A} diesel cut is higher than the cetane index of P_{B} diesel cut by more than 4 points.

Further, the recovered CO₂ was transported by pipeline and injected into a field depleted in oil located less than 80 km from the facility (I).

The H₂S produced in the hydrotreatment HDT and hydroconversion HDK steps was also recovered by washing the corresponding hydrogen circuits with a solution of MEA (monoethanolamine), and that H₂S was recompressed and injected into an aquifer.

### Example 2

The desulphurizing treatment steps for V-G-O and D-A-O were carried out separately:
V-G-O was treated by mild fixed bed hydrocracking M-HDK for a conversion of 40% by weight of gas oil and lighter cuts, to obtain an effluent containing less than 20 ppm of sulphur;
the D-A-O was treated by moderate pressure ebullated bed hydrocracking HDC for a conversion of 60% by weight of vacuum distillate and lighter compounds, to obtain an effluent containing less than 1000 ppm of sulphur;
the mild hydrocracking M-HDK effluent was mixed with the hydrotreated middle distillates D-M and 70% by weight of naphtha N to form the residual oil P_{A};
the asphalt, stored at 230° C., was mixed with the total hydroconversion effluent HDC and 30% by weight of naphtha N was added to form the residual oil P_{B}.

The same operations described in Example 1 were carried out as regards H₂S and CO₂.

### Example 3

The operations carried out in Example 1 were repeated except for the use of asphalt: the asphalt was used, fluxed with 30% by weight of crude oil with respect to the quantity of asphalte to produce a heavy burning fuel which was burned in a power station combined with a seawater desalination facility. Thus, only pre-refined oil free of asphaltenes P_{A} was produced.

1. Use, in a gas production region, of a purified field gas G in which:
a) at least a fraction of G1 of said gas G is converted to obtain a stream of hydrogen (H₂);
b) a conventional fluid transportable crude oil P1 with a pour point of 0° C. or less, comprising a vacuum residue with a sulphur content of more than 1% by weight, is selected and supplied via a unheated pipeline of unheated oil tanker;
c) said oil P1 is treated in a hydrocarbon treatment facility (I), carried out substantially without carbon discharge, the treatment comprising
at least one desulphurizing treatment step by hydrotreatment (HDT, RHDT) or hydroconversion (HDC, RHDC) or hydrocracking (HDK) of at least a fraction of the oil P1, said fraction mainly comprising compounds with a boiling point of more than 343° C., said step consuming at least a fraction of the stream H₂
at least one step, which may be communal with or separate to said desulphurizing treatment step, for reducing the quantity of vacuum residue included in the oil P1, by segregation of a part of the whole vacuum residue, optionally with conversion of a part of said vacuum residue, in which complete segregation of at least the asphaltenes of said vacuum residue is carried out;
so as to produce:
at least one pre-refined oil Pₐ comprising compounds derived from the desulphurizing treatment step, said pre-refined oil Pₐ being substantially free of asphaltenes, having a sulphur content that is reduced by at least 50% and a vacuum residue content with a sulphur content of more than 1% by weight which is zero or reduced by at least 15% with respect to the oil P1,
and at least a segregated fraction comprising at least the major portion of the asphaltenes, optionally cracked and/or supplemented with other fractions from P1, in the form of a liquid heavy fuel, or a residual oil P_{b} which is liquid at ambient temperature as an oil refinery feedstock intended to be refined in an oil refinery.
d) and said pre-refined oil P_{A} is evacuated to an oil port as an oil refinery feedstock intended to be refined in an oil refinery which is distinct and distant from the facility (I)

2. Use of a gas according to claim 1, in which said segregated fraction is said residual oil P_{B} which is liquid at ambient temperature as an oil refinery feedstock intended to be refined in an oil refinery feedstock, P_{B} comprising at least five cutes from the group formed by: light naptha, heavy naptha, kerosene, gas oil, vacuum gas oil, vacuum residue, and comprising at least 3% of its total weight in at least 5 of said cuts.

3. Use of a gas according to claim 1, in which one of the two oils P_{A}, P_{B} differs from the other by at least 15% in at least one of the following parameters: the percentage by weight of kerosene, the percentage by weight of diesel, the percentage by weight of vacuum residue containing more than 1.25% of sulphur.

4. Use of a gas according to claim 1, in which the oil fraction P_{A} boiling above 343° C. is a desulphurized fraction with a sulphur content of less than 1% by weight, derived from said desulphurizing treatment (HDC, HDT, HDK).

5. Use of a gas according to claim 1, in which said treatment comprise at least one catalytic step, carried out over a solid supported hydrotreatment, hydroconversion or hydroconversion catalyst, for at least a fraction of the feed comprising compounds with a boiling point of more than 371° C.

6. Use of a gas according to claim 1, in which:
at least an atmospheric distillate, a vacuum distillate and a vacuum residue are produced by atmospheric distillation and vacuum distillation of the oil P1;
at least a portion of said vacuum residue is deasphalted to obtain a deasphalted oil and asphalt;
said desulphurizing treatment (HDC, HDT, HDK) is carried out on the vacuum distillate and deasphalted oil; separately or as a mixture, to obtain an effluent with a sulphur content of less than 1% by weight
said pre-refined oil P_{A} which is substantially free of asphaltenes and comprises no vacuum residue with a sulphur content of more than 1% by weight is reconstituted from at least a portion of the effluents from said desulphurizing treatment and at least a portion of the atmospheric distillate.

7. Use of gas according to claim 1, in which:
at least an atmospheric distillate, a vacuum distillate and a vacuum residue are produced by atmospheric distillation and vacuum distillation of the oil P1;
at least a portion of said vacuum residue is deasphalted to obtain a deasphalted oil and asphalt;
a residual oil P_{B} comprising at least the major portion of the asphalt obtained along with a limited quantity of relatively lighter fractions is produced so that the asphaltenes content of the vacuum residue of the oil P_{B} is greater than the vacuum residue of the oil P1 by at least 20%, said content preferably being greater than 12% by weight or even than 14% by weight.

8. Use of a gas according to claim 7, in which said relatively lighter fractions are derived from the treatment of oil P1 and comprise a portion of the effluents from said desulphurizing treatment.

9. Use of a gas according to claim 7, in which said relatively lighter fractions are principally composed of crude oil.

10. Use of a gas according to claim 1, in which:
at least an atmospheric distillate, a vacuum distillate and a vacuum residue are produced by atmospheric distillation and vacuum distillation of the oil P1;
the vacuum residue is converted by catalytic hydroconversion (RHDC), and one or more fractions from the oil P1 is optionally added to the effluents from said catalytic hydroconversion to produce said residual oil P_{B}

11. Use of a gas according to claim 1, in which:
at least an atmospheric distillate and an atmospheric residue is produced by atmospheric distillation of the oil P1;
the atmospheric residue is converted to catalytic hydroconversion (RHDC);
at least a portion of the effluents from said catalytic hydroconversion is fractionated into one or more non-residual fractions to form the refined oil P_{A} by mixing, after adding at least a portion of said atmospheric distillate, optionally desulphurized, and adding the complementary portion of the effluents from the treatement of the oil P1 to produce the residual oil P_{B}

12. Use of a gas according to claim 1, in which no combustion nor gasification nor evacuation of asphalt, nor coke forming process is carried out, and in which the liquid yield is over 97% by weight.

13. Use of gas according to claim 1, in which:
at least an atmospheric distillate, a vacuum distillate and a vacuum residue is produced by atmospheric distillation and vacuum distillation of the oil P1;
said residue is deasphalted to obtain a deasphalted oil and asphalt;
said desulphurizing treatment (HDC, HDT, HDK) is carried out on the vacuum distillate and deasphalted oil, used alone or as a mixture, to obtain an effluent having a sulphur content of less than 1% by weight;
said pre-refined oil P_{A} which is substantially free of asphaltenes and comprises no vacuum residue with a sulphur content of more than 1% by weight is reconstituted from at least the major portion of the effluents from said desulphurizing treatment and from atmospheric distillation;
the major portion or, preferably, all of the asphalt, preferably fluxed, is burned as a fuel for facility (I) and/or for a power station and/or for a seawater desalination plant.

14. Use of a gas according to claim 1, in which at least a portion of the CO₂ co-produced during conversion of the gas G1 to hydrogen is recovered and said CO₂ is injected underground into the gas production region close to the facility (I)

15. Use of a gas according to claim 14, in which the CO₂ is injected into an oil and/or gas field to sequestrate said CO₂ and/or to carry out assisted oil recovery.

16. Use of a gas according to claim 6, in which the CO₂ is injected into an oil field, for example a depleted field to carry out assisted oil recovery.

17. Pre-refined oil P_{A} produced by the gas use according to claim 1.

18. Residual oil P_{B} produced by the gas use according to claim 1.
